(19) United States
(12) Patent Application Publication
(10) Pub. No.: US 2015/0308976 A1
(43) Pub. Date: Oct. 29, 2015

(54) SENSOR EMPLOYING INTERNAL REFERENCE ELECTRODE

(71) Applicant: Technical University of Denmark, Kgs. Lyngby (DK)

(72) Inventors: Qiang Hu, Roskilde (DK); Karin Vels Hansen, Nyborg (DK); Mogens Mogensen, Lynge (DK)

(73) Assignee: TECHNICAL UNIVERSITY OF DENMARK, Kgs. Lyngby (DK)

(21) Appl. No.: 14/395,828

(22) PCT Filed: Apr. 23, 2013
(86) PCT No.: PCT/EP2013/058342

§ 371 Date: Oct. 21, 2014

(30) Foreign Application Priority Data
Apr. 23, 2012 (EP) 12002819.6

(51) Int. Cl. G01N 27/407

(52) U.S. Cl. CPC G01N 27/407; G01N 27/4075; G01N 27/4076; G01N 27/4073

(57) ABSTRACT

The present invention concerns a novel internal reference electrode as well as a novel sensing electrode for an improved internal reference oxygen sensor and the sensor employing same.

The present invention concerns a novel internal reference electrode as well as a novel sensing electrode for an improved internal reference oxygen sensor and the sensor employing same.

### PRIOR ART

Oxygen sensors are employed in a wide variety of applications such as control of the oxygen content of inert gases used in the food industry, welding applications but also for the control of combustion processes. Additionally oxygen sensors are also used as a component for other electrochemical devices such as nitrogen oxides sensors and wide range air-to-fuel oxygen sensor.

An electrochemical oxygen sensor comprises a reference electrode, a sensing electrode and a solid electrolyte separating the reference electrode from the sensing electrode. The oxygen sensor works by the Nernst equation:

$${V}_{cell} = \frac{RT}{4 F} ln \frac{{p}_{S}}{{p}_{R}} \qquad ( 1 )$$

where V_{cell} is the cell voltage, R is the gas constant, 8.314 J·mol⁻¹·K⁻¹, T is the temperature in Kelvin, F is the Faraday constant, 96485 C·mol⁻¹, p_{S} and p_{R} are oxygen partial pressures at the sensing electrode and the reference electrode, respectively. Oxide ion conductors such as stabilized ZrO₂, CeO₂ and ThO₂ are well-known materials used for the solid electrolyte, but yttria stabilized zirconia (YSZ) is the most popularly employed. The cell voltage V_{cell} is developed by virtue of the difference in the oxygen partial pressures between the two electrodes, the reference electrode and the sensing electrode. To determine the oxygen content at the sensing electrode, i.e. p_{S}, the oxygen content at the reference electrode p_{R} must be known. Air with a known oxygen partial pressure of approximate 0.2 bar is commonly used to provide a well-defined oxygen partial pressure for the reference electrode. However, delivery of the reference air requires a rather complex sensor structure and prevents a broader use of such sensors, as in some applications delivery of the reference air is very difficult or even impossible.

There have been efforts to develop an internal reference oxygen sensor in which the reference air is replaced by a binary mixture of metal and its oxide. According to the Gibbs phase rule the equilibrium oxygen partial pressure of such a binary mixture is fixed at a given temperature and can be determined by thermodynamics. Hence, this determinable oxygen partial pressure can be used as the reference oxygen content and the unknown oxygen content of the sample gas can be obtained from the Nernst equation.

Internal reference oxygen sensors comprising such a reference electrode made of a binary mixture of metal and its oxide have been described in U.S. Pat. No. 4,345,985, U.S. Pat. No. 4,107,019, U.S. Pat. No. 5,308,469, U.S. Pat. No. 5,827,415, US 2009/0078025, J. Electrochem. Soc. 148 G91-94, Rev. Sci. Instrum. 73 156-161 and Sens. Actuators B124 192-201, respectively. However, these internal reference oxygen sensors have never found commercial application, due to the unsatisfactory performance, especially in the aspects of stability, accuracy and reproducibility, which to a large extent is caused by the inappropriate electrode structure. The sensing electrode of known internal reference oxygen sensors is made of noble metals such as silver or platinum. However it has been revealed in our experimental work that these noble metals may result in poor measurement accuracy.

Apparently a need exists to improve the performance of the present internal reference oxygen sensors so that they can be widely accepted by practical applications. Surprisingly, the inventors of the present invention have found that by including further materials to the metal binary mixture of metal and its oxide, an electrode material has been formed possessing excellent properties, such as excellent performance as indicated by the accurate, fast and stable response. Meanwhile both cell performance and fabrication are highly reproducible.

### OBJECT OF THE PRESENT INVENTION

It is the object of the present invention to provide an improved internal reference electrode to be used in an oxygen sensor. A further object is the provision of an improved sensing electrode to be used in an oxygen sensor, which in particular avoids the use of platinum or silver as the electrode material. Finally the present invention aims at providing a novel and improved oxygen sensor comprising the novel internal reference electrode and optionally the novel sensing electrode. It will be seen below that the internal reference oxygen sensors in accordance with the present invention have excellent performance as indicated by the accurate, fast and stable response. Meanwhile both cell performance and fabrication are highly reproducible.

### BRIEF DESCRIPTION OF THE PRESENT INVENTION

These objects have been solved by the subject matter as defined in the patent claims. Further preferred embodiments are described in the following. The terms composite sensing electrode, sensing electrode and SE on the one hand and composite internal reference electrode, internal reference electrode and IRE on the other hand are used herein interchangeably; they refer to the same subject matter.

The present invention in particular, compared to existing technologies, provides reference and sensing electrodes which are easier to install due to the avoidance of standard air reference oxygen sensors. An oxygen sensor comprising the internal reference electrode (IRE) as well as the sensing electrode (SE) in accordance with the present invention is referred to as an internal reference oxygen sensor (IROS) and it enables highly reliable and reproducible measurement results, it shows excellent stability, fast response, and suitable working temperature as low as about 260° C. as compared with working temperatures of conventional IROSes, which typical works at temperatures higher than 400° C. ranges. In particular the use of expensive electrode materials such as platinum can be avoided.

### BRIEF DESCRIPTION OF THE FIGURES AND TABLES

FIG. 1A shows photo of two IROSes, both with foot print ca. 10×10 mm.

FIG. 1B shows cross section structure a polished IROS.

FIG. 2 shows voltage sweeps that are close to potential sweeps versus the SE in air of an IRE in an IROS. The potential sweeps were cyclically performed between 0 and −2.0 V for four times, but only the sections between 0 to −1.15 V of the first and the second sweeps were presented here for clarity.

FIG. 3A-3C show comparison of the measured cell voltage (V_{cell}) with the theoretical cell voltage (Vₜₕₑₒ) at three pO₂levels: 0.0164 atm (FIG. 3A), 0.21 atm (FIG. 3B) and 1 atm (FIG. 3C).

FIG. 4 shows cell voltage variation in the course of pO₂ cycling.

FIG. 5 shows effects of IRE reduction degree on cell voltage stability.

FIG. 6 shows stability test of an appropriately reduced IROS.

FIG. 7 shows the impedance spectra and cell voltage before and after a thermal cycling between 667° C. and 29° C., indicating that the good cell electrochemical properties were well maintained after the thermal cycling.

FIG. 8 shows a possible structure, which only measures sample pO₂, of an IROS in accordance with the present invention.

FIG. 9 shows a possible structure, which measures cell temperature and sample pO₂ at same time, of an IROS in accordance with the present invention.

FIG. 10 shows a possible structure of an IROS in accordance with the present invention. The structure integrates a heater and requires no external heating devices for cell operation.

FIG. 11 shows schematically the structure of a composite sensing electrode in accordance with the present invention.

FIG. 12 shows schematically the structure of composite internal reference electrode in accordance with the present invention.

FIG. 13 shows the structure of a miniature IROS in accordance with the present invention.

FIG. 14 shows an exemplified structure of an internal reference electrode in accordance with the present invention. YSZ: yttria stabilized zirconia, SDC: samaria doped ceria.

FIG. 15 shows an exemplified structure of a sensing electrode in accordance with the present invention. YSZ: yttria stabilized zirconia, SDC: samaria doped ceria, LSM: lanthanum strontium manganite.

Table 1 lists the measured cell voltages (V_{cell}) and the error (ε) at three temperatures (263° C., 469° C., 664° C.) for cells 1 to 5. Cell 1: IRE/ScYSZ/Pt, cell 2: IRE/ScYSZ/CSE, cell 3: IRE/ScYSZ/CSE(SDC20), cell 4: IRE(SDC20)/ScYSZ/CSE, cell 5: IRE(SDC20)/ScYSZ/CSE(SDC20).

### DETAILED DISCLOSURE OF THE INVENTION

An internal reference oxygen sensor (IROS) comprises a reference electrode, a sensing electrode and a solid electrolyte separating the reference electrode from the sensing electrode. As mentioned above the oxygen sensor works by the Nernst equation:

$${V}_{cell} = \frac{RT}{4 F} ln \frac{{p}_{S}}{{p}_{R}} \qquad ( 1 )$$

In the internal reference electrode, oxygen molecules do not necessarily exist. In cases where oxygen molecules do not exist, the general electrode process can be expressed as:

MOₓ+2e⁻ [symbol] M+xO²⁻ (2)

where MOₓ and M denote the metal oxide constituent and the metal constituent of the binary mixture, and O²⁻ and e⁻ indicate the divalently charged oxide ions and monovalently charged electrons, respectively. An internal reference oxygen sensor can give an accurate and stable response only if the electrode reaction indicated by Eq. (2) reaches a complete thermodynamic equilibrium and the thermodynamic state of the internal reference electrode is therefore well-defined.

As known from Eq. (2), a joint participation of metal oxide MOₓ, metal M, oxide ions O²⁻ and electrons e⁻ is required to facilitate the establishment of the thermodynamic equilibrium between the binary mixture constituents. In general the metal M has a good electron activity, as indicated by the high electron conductivity, but in most cases, neither the metal M nor the metal oxide MOₓ has a sufficient activity for oxide ions O²⁻ so that the thermodynamic equilibrium between the binary mixture constituents is able to be established completely and rapidly. Therefore in the known internal reference electrode where the metal M and the metal oxide MOₓ are simply mixed to enable contacts with each other, the thermodynamic equilibrium between the two constituents of the binary mixture is very difficult to be thoroughly and rapidly realized in the scale of entire electrode. Only at the boundary sections between the internal reference electrode and the solid electrolyte, it is possible for the electrolyte to provide a limited oxide ion activity.

In the present invention, establishment of the thermodynamics equilibrium of a binary mixture is significantly enhanced, in the scale of entire internal reference electrode, due to the presence of the further material(s) that are able to facilitate the establishment of the thermodynamic equilibrium between the constituents of a binary mixture for instance by supplying extraordinary oxide ions activity. However it should be understood that the further material(s) herein are not limited to materials that can provide extraordinary oxide ion activity. The further materials thereof indicate any materials other than the two constituent of the binary mixture that are able to provide extraordinary activities to facilitate the establishment of the thermodynamic equilibrium between the two constituents of a binary mixture.

The particles of an internal reference electrode in accordance with the present invention comprise the binary mixture of metal and its metal oxide and the further materials, and these particles should be dispersed, in the scale of entire electrode, as fine as possible, since that can significantly increase the contact area between these particles. The increased contact area between the particles can enhance the electrode reactions, resulting in an active electrode that can reach the thermodynamic equilibrium rapidly and completely.

In order to prepare an active electrode in which the particles are finely dispersed, electrode preparation needs to be carried out very carefully. Preparation methods for an internal reference electrode include powder mixing from the beginning of the electrode preparation, ion impregnation, electrochemical reduction of the precursor oxides and other techniques well-known to people skilled in this art. During the dispersion process, the further materials are preferred to be dispersed in a fine way i.e. in nano scales less than 100 nm.

When the equilibrium oxygen partial pressure of a binary mixture is sufficiently high, real oxygen molecules may exist. For example the equilibrium oxygen partial pressure of a binary mixture in general increases with the increase in temperature, and real oxygen molecules may be present at a sufficiently high temperature. In such cases, the general electrode processes can be expressed as:

$${MO}_{x} ⇌ M + \frac{x}{2} {O}_{2} \qquad ( 3 )$$

where O₂ indicates oxygen molecules. Apparently, the provision of further materials that are able to facilitate the dissociation of oxygen molecules or association of oxide ions can enhance the establishment of the thermodynamic equilibrium between the two constituents of the binary mixture. The further materials thereof again mean the materials other than the constituents of the binary mixture of M/MOₓ that are added and dispersed within the entire electrode to facilitate the establishment of the thermodynamic equilibrium between the two constituents of the binary mixture. In one embodiment the further materials are not a noble metal. In particular, in some embodiments the further materials are not platinum or silver.

Similar scenario applies to the electrode process of a sensing electrode. The general electrode processes at a sensing electrode can be in principle described as:

O₂+4e⁻ [symbol] 2O²⁻ (4)

which indicates that the oxygen molecules O₂ are dissociated into oxide ions O²⁻, with provision of electrons e⁻. A completely and rapidly realized thermodynamic equilibrium of the reaction indicated by Eq. (4) is equally vital to determine the accuracy and stability of an internal reference oxygen sensor. The electrode process needs a joint participation of oxygen molecules, electrons and oxide ions. Usually it is very hard to find a material of single component that is active for oxygen molecule (dissociation), electron and oxide ion transport at same time. For example, platinum is the dominant material used for the sensing electrode of known oxygen sensors, and other noble metals such as silver and gold are sometimes employed. Though these metal electrodes usually show good electron conductivity and catalytic activity for oxygen molecule (dissociation) at a moderately high temperature such as 500° C., they are only poorly surface conductive for oxide ions.

In the present invention the establishment of the thermodynamic equilibrium of the electrode reaction of a sensing electrode is enhanced significantly by fabricating a sensing electrode consisting of more than one components and every component has a particular activity for the participant(s) of the electrode process indicated by Eq. (4). The overall electrode process taking place at the sensing electrode is thus enhanced and the thermodynamic equilibrium of a sensing electrode can then be established rapidly and completely. Furthermore the components of the sensing electrode in accordance with the present invention are preferably made of oxide materials.

Hence the present invention provides a novel internal reference electrode, a novel sensing electrode for an internal reference electrode. The novel internal reference electrode contains further materials other than the binary mixture and the novel sensing electrodes consist of particles made of at least two materials. The particles comprising the novel internal reference electrodes and the novel sensing electrode in accordance with the present invention are both dispersed very finely. The particles comprising the novel sensing electrode is preferable made of oxide materials instead of noble metals such as platinum and silver.

Hence, the present invention provides an improved structure for the internal reference electrode as well as for the sensing electrode for an oxygen sensor, by replacing the known air reference and the known internal reference sensors based on a binary mixture of metal/metal oxide used in combination with a precious metal electrode, with composite ceramic electrodes, preferably with a nanostructured three dimensional network.

In the case of the IRE, this electrode comprises a dispersed internal reference based on a binary mixture of metal/metal oxide (distributed within the three dimensional ceramic network). A corresponding structure likewise is used for the sensing electrode, where again the use of precious metals can in some embodiments be avoided. In both, the IRE as well as in the SE of the present invention a mixture of materials has to be present to provide the desired functionality.

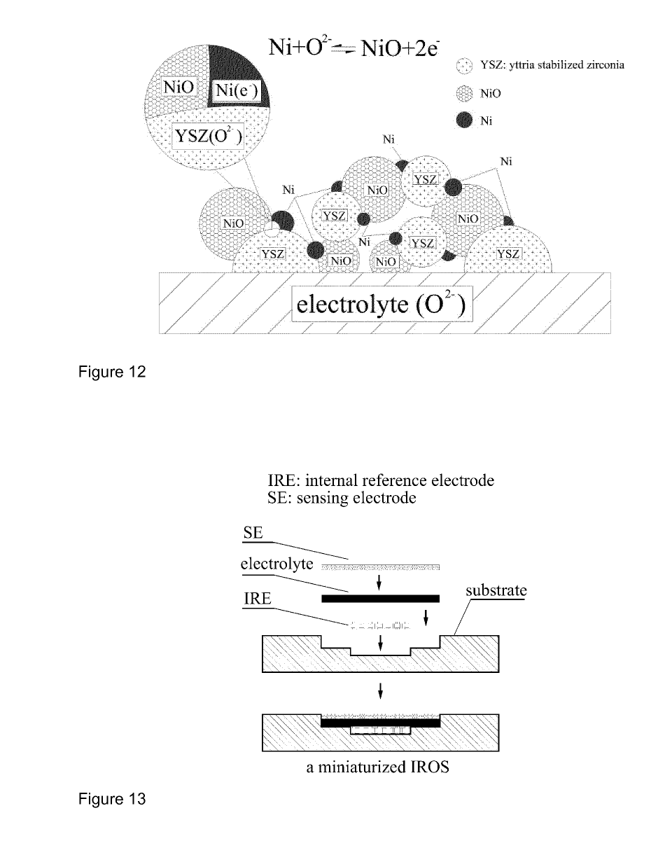

FIGS. 11 and 12 show the relevant, novel and inventive features of the IRE/SE of the present invention.

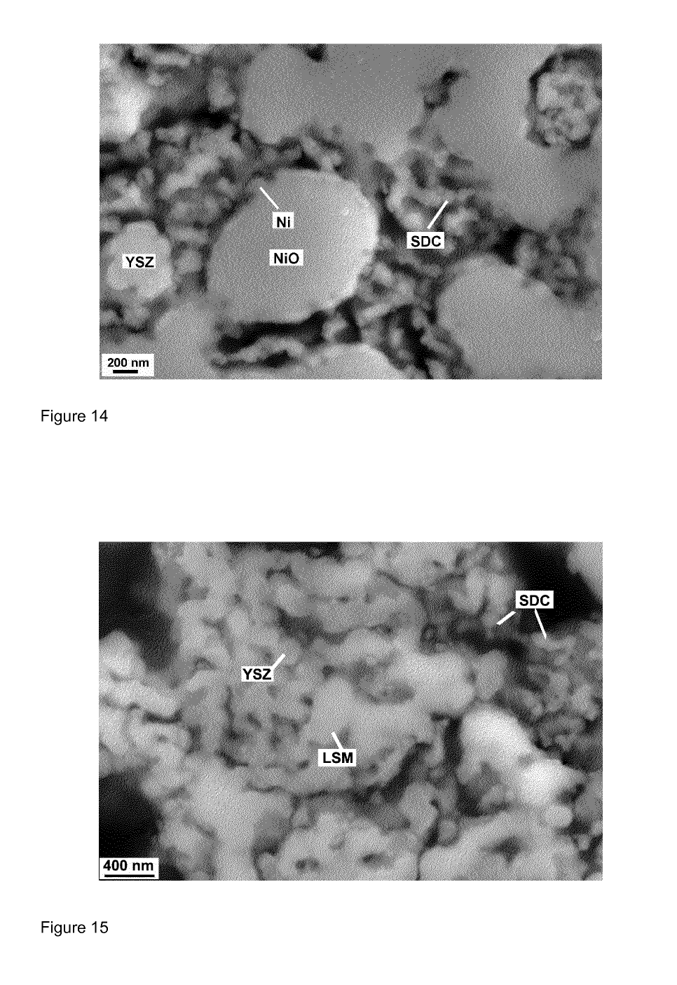

FIG. 14 shows the structure of an exemplified internal reference electrode in accordance with the present invention. The binary mixture in the exemplified internal reference electrode is Ni/NiO. The further materials are yttria doped zirconia (YSZ) and samaria doped ceria (SDC). It is seen that the both Ni and SDC particles are dispersed in a size below 100 nm. On the other hand the NiO particles have a relatively larger size of ca. 2 μm and the size of the YSZ particles is ca. 500 nm.

FIG. 15 shows the structure of an exemplified sensing electrode in accordance with the present invention. The electrode consists of particles made of three materials: yttria stabilized zirconia (YSZ), samaria doped ceria (SDC) and lanthanum strontium manganite (LSM). It is seen that SDC particles are dispersed in a size below 100 nm, the YSZ particles are dispersed in a size of ca. 200 nm, LSM particles are dispersed in a size of ca. 500 nm.

In FIG. 12 the structure of an IRE of the present invention is shown. The metal component (here nickel), the metal oxide component (here nickel oxide) and the inorganic oxide material (here YSZ) provide a three dimensional network structure characterized in particular by the finely dispersed metal component. The three dimensional network linking points (Ni/NiO/YSZ; triple phase boundaries) enable the function of this complex material mixture to function reliably as IRE.

In FIG. 11 the similar principle structure of the SE is shown, comprising two materials in order to provide electron and ion conductivity, respectively (here LSM for electron conductivity and YSZ for ion conductivity). The matrix structure of these two materials provides a three dimensional network structure, so that at suitable contact points a triple phase boundary is given (YSZ/LSM/O₂) so that the sensing electrode can provide its function.

By using the internal reference electrode and/or the sensing electrode of the present invention an overall improved IROS is provided with excellent performance, low fabrication cost, and the potentials for miniaturization and mass fabrication in addition to robust structure; conventional systems are rather delicate and fragile. Furthermore the novel IROS enables far lower operation temperatures compared to conventional air reference electrodes (higher than 700° C.) and conventional internal reference electrodes such as those described in the introduction (higher than 400° C.). The novel IROS in accordance with the present invention enables operation temperatures as low as about 260° C. The lower working temperatures of the IRE, the SE as well as of the IROS of the present invention in particular enables the maintenance of nano-structured electrodes, which under the conventional high temperature working conditions would be degraded over time. Such nano-structured electrodes, in accordance with the present invention however enable the realization of advantages, such as small sized IROS, higher measurement accuracy etc. Furthermore the stability and measurement reliability is very good.

The internal reference electrode in accordance with the present invention furthermore may be regenerated by simple means, thereby further prolonging service time, which in turn also reduces costs. Due to the use of materials which enable production methods including screen printing methods and deposition techniques, such as chemical vapour deposition (CVD), physical vapour deposition (PLD), photolithography, miniaturized sized IROS may be fabricated, which will broaden the fields of application.

In the following the various aspects of the present invention are described, followed by specific examples provided for illustrating the present invention. It should be understood that the different aspects including the internal reference electrode, the sensing electrode and the internal reference oxygen sensor described herein as well as all preferred embodiments for these aspects can be combined in any combination, e.g. any specific embodiment for the internal reference electrode may be combined in an internal reference oxygen sensor with a preferred embodiment of the sensing electrode, etc.

### The Internal Reference Electrode of the Present Invention

The novel internal reference electrode in accordance with the present invention, which is to be used in suitable for an IROS, neither requires an external air or gas supply nor the use of a precious metal such as platinum or silver as electrode material.

The novel internal reference electrode of the present invention is based on the use of the known binary mixture of metal/metal oxide (i.e., a metal and its oxide) also employed in the prior art. Surprisingly it has been found however that it is possible to replace the precious metal, typically platinum or silver electrode with a material or material mixture which provides ion conductivity as well as electron conductivity, typically a ceramic/oxide material, as shown in FIG. 12. This additional further material serves as the matrix material with the binary mixture metal/metal oxide being dispersed therein. Accordingly the IRE in accordance with the present invention comprises a binary mixture of metal/metal oxide and further materials. The further materials can be an oxide ion conductor or an electron conductor or a mixture thereof, or a mixed conductor that has both oxide ion conductivity and electron conductivity, or a mixture thereof, or a mixture of an oxide ion conductor and a mixed conductor thereof, or a mixture of an electron conductor and a mixed conductor thereof. The further materials are preferably made from inorganic oxide material, preferably selected from oxide materials known in the art as refractory oxides and or known in the art as oxide materials for oxygen electrodes of solid oxide fuel cell (SOFC) as well as materials known as electrolyte materials. Surprisingly it has been found that by using such a material mixture improved performances can be achieved despite the fact that the platinum (or precious metal) electrode previously deemed to be indispensable has been replace with a far cheaper material.

Preferred examples of the binary mixture of metal/metal oxide and the further (different) inorganic oxide are given below.

Examples of binary mixtures of metal/metal oxide include:

All known examples of such mixtures may be employed in accordance with the present invention such as binary mixtures of nickel/nickel oxide, palladium/palladium oxide, iron/iron oxide, cobalt/cobalt oxide, copper/copper oxide, tungsten/tungsten oxide, titanium/titanium oxide, vanadium/vanadium oxide, chromium/chromium oxide, manganese/manganese oxide, zinc/zinc oxide, niobium/niobium oxide, molybdenum/molybdenum oxide, ruthenium/ruthenium oxide, rhodium/rhodium oxide, silver/silver oxide, cadmium/cadmium oxide, indium/indium oxide, tin/tin oxide, antimony/antimony oxide, tellurium/tellurium oxide, tantalum/tantalum oxide, rhenium/rhenium oxide, osmium/osmium oxide, iridium/iridium oxide, platinum/platinum oxide, thallium/thallium oxide, lead/lead oxide, preferably nickel and nickel oxide, palladium and palladium oxide, cobalt and cobalt oxide, iron and iron oxide, as well as rhodium and rhodium oxide, in particular preferred is a binary mixture of nickel and nickel oxide and a binary mixture of palladium and palladium oxide. Other examples include tin and tin oxide. Since it is possible to generate the metal component of the binary mixture after the preparation of the principle IRE structure in situ by means of suitable reduction methods, a finely dispersed binary mixture metal/metal oxide may be obtained, so that the above identified advantages can be achieved. Due to the lower operational temperatures of the IRE of the present invention this finely dispersed state further can be maintained for a long period of time.

Examples of the further material, which acts as ion conductor/electron conductor to provide (inorganic oxide material) also designated herein as material or material mixture providing ion and electron conductivity include:

Typical ceramic materials and refractory metal oxides or mixed metal oxides as well as materials known as electrolyte, including doped materials may be employed as the further component for the IRE of the present invention.

By the term “ceramic materials” as used herein is meant inorganic crystalline materials.

By the term “refractory metal oxides” as used herein is meant metal oxides able to withstand temperatures above 1500° C. without chemical change and physical destruction.

Suitable examples of the further material other than the binary mixture include:

1) Undoped perovskites with general formula:
PMO₃ where P═La, Sr, and M=Sc, Ti, V, Cr, Mn, Fe, Co, Ni, Cu, Zn, Ga, Ge, Al.

2) Layered oxides with undoped perovskite-like structures with general formula:
P₂MO₄ where P═La, Sr and M=Sc, Ti, V, Cr, Mn, Fe, Co, Ni, Cu, Zn, Ga, Ge, Al.

3) A-site doped perovskites with general formula:
(P₁₋ₓQₓ)_{y}MO₃ where P═La, Y, Pr, Tb, Q=Ca, Sr, Ba, and M=Sc, Ti, V, Cr, Mn, Fe, Co, Ni, Cu, Zn, Ga, Ge, Al (with 0≦x≦1 and 0 y≦1, preferably 0.25≦x≦0.55 and 0.95≦y≦1).

4) A- and B-site doped perovskites with general formula:
(P₁₋ₓQₓ)M_{1-y}N_{y}O₃ where P═Y, Ca, Sr, Ba, Ce, Pr, Nd, Sm, Eu, Gd, Tb, Dy, Ho, Er, Tm, Yb, Lu, Q=Y, Ca, Sr, Ba, Pr, Nd, Sm, Eu, Gd, Tb, Dy, Ho, Er, Tm, Yb, Lu such that the elements chosen for P and Q are different from each other; M=Sc, Ti, V, Cr, Mn, Fe, Co, Ni, Cu, Zn, Ga, Ge, Al and N═Sc, Ti, V, Cr, Mn, Fe, Co, Ni, Cu, Zn, Ga, Ge, Al such that the elements chosen for M and N are different from each other, with 0≦x≦1 and 0≦y≦1, preferably 0.25≦x≦0.55 and 0.25≦y≦0.55;

5) Zirconia based solid solutions:
ZrO₂-MO where M=Mg, Ca.
ZrO₂-M₂O₃ where M=Sc, Y, La, Pr, Nd, Sm, Eu, Gd, Tb, Dy, Ho, Er, Tm, Yb, Lu.
ZrO₂—Bi₂O₃-M₂O₃ where M=Sc, Y, La, Pr, Nd, Sm, Eu, Gd, Tb, Dy, Ho, Er, Tm, Yb, Lu.

6) Hafnia based solid solutions:
HfO₂-MO where M=Mg, Ca.
HfO₂-M₂O₃ where M=Sc, Y, La, Pr, Nd, Sm, Eu, Gd, Tb, Dy, Ho, Er, Tm, Yb, Lu.

7) Ceria based solid solutions:
CeO₂-MO where M=Mg, Ca, Sr.
CeO₂-M₂O₃ where M=Sc, Y, La, Pr, Nd, Sm, Eu, Gd, Tb, Dy, Ho, Er, Tm, Yb, Lu.

8) Thoria based solid solutions:
ThO₂-MO where M=Mg, Ca, Sr, Ba.
ThO₂-M₂O₃ where M=Sc, Y, La, Pr, Nd, Sm, Eu, Gd, Tb, Dy, Ho, Er, Tm, Yb, Lu.

9) Urania based solid solutions:
UO₂-MO where M=Mg, Ca, Sr, Ba.
UO₂-M₂O₃ where M=Sc, Y, La, Pr, Nd, Sm, Eu, Gd, Tb, Dy, Ho, Er, Tm, Yb, Lu.

10) Bismuth oxide based solid solutions:
Bi₂O₃-MO where M=Mg, Ca, Sr, Ba, Pb.
Bi₂O₃-M₂O₃ where M=Sc, Y, La, Pr, Nd, Sm, Eu, Gd, Tb, Dy, Ho, Er, Tm, Yb.
Bi₂O₃—WO₃.
Bi₂O₃.(PbO)₁₋ₓ.(CaO)ₓ, with 0≦x≦1, preferably 0.4≦x≦0.8.

11) Oxygen saturated fluorites:
CaF₂—CaO.
BaF₂—BaO.
   and any mixtures thereof.

Preferred is the use of zirconia, preferably yttria stabilized zirconia (YSZ). Also preferred is the use of gadolinia doped ceria (GDC) and samaria doped ceria (SDC). It is possible however to use also a mixture of such materials. Thereby properties of an internal reference electrode of the present invention can be tailored further, such as conductivity/thermal expansion/mechanical properties etc.

In order to prepare the IRE of the present invention it is in principle possible to simply mix the components and then to prepare the IRE by conventional techniques, such as printing (by using a slurry of the material mixture) or other conventional methods. Advantageously it is however possible to use as starting materials for the preparation of the IRE only the metal oxide of the binary mixture and the ion conductor/electron conductor, since the metal itself may be obtained later after formation of the principle structure/form of the IRE by means of a partial reduction of the metal oxide to the metal (for example using a suitable externally applied voltage; or by any other means such as chemical reduction, as long as the reduction process is not detrimental to the structure/function/integrity of the final IRE). This already simplifies the production process of the IRE of the present invention.

Preparation methods of an internal reference electrode of the present invention include powder mixing from the beginning of an electrode fabrication, ion impregnation, electrochemical reduction of a precursor oxide and other techniques well-known to people skilled in this art. During the dispersion process, the further materials are preferred to be dispersed in a fine way i.e. in nano scales less than 100 nm, in order to increase significantly the contacts between the further materials and the constituents of the binary mixture, from which sensor performance can be improved greatly, especially in the aspects of accuracy and stability.

A further surprising advantage of this way of preparing the IRE is the fact that thereby a very finely dispersed structure of the binary mixture metal/metal oxide can be prepared in the matrix of the ion conductor/electron conductor.

A preferred method to realize a finely dispersed binary mixture can be partially reducing the corresponding precursor oxide by chemical or electrochemical method, i.e. applied an appropriate voltage over an electrode containing a precursor oxide. Taking the formation of a binary mixture of Ni/NiO for example: at first the precursor oxide of NiO particles is made into an internal reference electrode, then the NiO particles are partially reduced by electrochemical method, i.e., applying an appropriate voltage across the electrode for a proper period to form a large amount of fine Ni particles. Thereby the binary mixture of Ni/NiO is created and the generated Ni particles by this method are dispersed very finely, i.e., in a size less than 100 nm, preferably less than 50 nm.

A preferred method to add and disperse finely the further materials other than the binary mixture can be the so-called ion impregnation. During the ion impregnation, solutions such as the nitrate solutions serving as the precursor of target oxides are impregnated into an electrode, then an appropriate heat treatment is carried out to decompose the precursor solution and form the finely dispersed target oxide particles within the entire electrode. For example, to create finely-dispersed samaria doped ceria particles within an internal reference electrode where a binary mixture of Ni/NiO locates, the nitrate solution of samarium and gadolinium are impregnated into an electrode made of the precursor oxide of NiO or the binary mixture of Ni/NiO, then the electrode is heated at an elevated temperature such as 700° C., the nitrate solution of samarium and gadolinium then is decomposed and the target oxides of samaria doped ceria can be formed and finely dispersed within the entire electrode. The generated samaria doped ceria particles by this method are dispersed very finely, i.e., in a size less than 100 nm, preferably less than 50 nm.

An alternative and also preferred method to add and disperse finely further material other than a binary mixture can be simply mixing further materials with a binary mixture or a precursor oxide of a binary mixture from the beginning of electrode preparation. For example, to add and disperse yttria stabilized zirconia (YSZ) particles for the binary mixture of Ni/NiO, YSZ particles can be simply mixed with the particles of the binary mixture of Ni/NiO or with the precursor oxide of NiO by the simple method of ball-milling and then the particles mixtures of YSZ/NiO/Ni or YSZ/NiO are sintered at high temperatures such as 1350° C. to be prepared as an internal reference electrode. By this simple method, YSZ particles can also be dispersed finely, i.e., in a size less than 1 μm, preferably less than 500 nm.

Typically it is possible in accordance with the present invention to provide a structure wherein the particle sizes of the material employed in the final electrode are in the range of less than 200 μm, preferably less than 100 μm, more preferably less than 50 μm. In embodiments it is possible to obtain particle sizes of below 10 μm, more preferable of below 2 μm and in particular it is preferred when at least one type of the particles (i.e. metal and/or metal oxide, and/or ion/electron conductor) has a particle size in the nano range, such as 100 nm or less, preferably 50 nm or less. These particle sizes may be determined by a scanning electron microscope. These particle sizes also apply to the sensing electrode described below. In fact a nanostructured IRE may be obtained thereby which further improves the performance of the IRE. Due to the fact that the reduction of the metal oxide may be carried out under mild condition, in particular at low temperatures, such nanostructured IRE may be obtained in a reliable way. High temperatures are not required during the preparation of the binary mixture (by reduction of the metal oxide) so that a nanostructure can be reliably prepared. In addition the composition of the IRE of the present invention offers the further benefit that a recovery of any depleted component of the binary mixture is possible by means of simple electrochemical reactions. Has for example the IRE suffered from increased oxidation of the metal component of the binary mixture (which may occur in situations of high oxygen partial pressure) it is possible to reduce again the part of the metal component which has been oxidized by using a battery.

The Sensing Electrode of the Present Invention

To enhance the overall electrode process taking place at a sensing electrode, a sensing electrode of this invention comprises at least two components, preferably made of oxide materials.

The materials for the SE are selected so that they provide the required functionality, i.e. electron conductivity and ion conductivity. Examples of suitable materials are inorganic oxides preferably selected from oxide materials known in the art as refractory oxides and or known in the art as oxide materials for oxygen electrodes of solid oxide fuel cells (SOFCs), including electrolyte materials. Surprisingly it has been found that by using such a material mixture improved performances can be achieved despite the fact that the platinum (or precious metal) electrode previously deemed to be indispensable has been replace with a far cheaper material.

Suitable materials for a sensing electrode of the present invention include:

1) Undoped perovskites with general formula:
PMO₃ where P═La, Sr, and M=Sc, Ti, V, Cr, Mn, Fe, Co, Ni, Cu, Zn, Ga, Ge, Al.

2) Layered oxides with undoped perovskite-like structures with general formula:
P₂MO₄ where P═La, Sr and M=Sc, Ti, V, Cr, Mn, Fe, Co, Ni, Cu, Zn, Ga, Ge, Al.

3) A-site doped perovskites with general formula:
(P₁₋ₓQₓ)_{y}MO₃ where P═La, Y, Pr, Tb, Q=Ca, Sr, Ba, and M=Sc, Ti, V, Cr, Mn, Fe, Co, Ni, Cu, Zn, Ga, Ge, Al (with 0≦x≦1 and 0 y≦1, preferably 0.25≦x≦0.55 and 0.95≦y≦1).

4) A- and B-site doped perovskites with general formula:
(P₁₋ₓQₓ)M_{1-y}N_{y}O₃ where P═Y, Ca, Sr, Ba, Ce, Pr, Nd, Sm, Eu, Gd, Tb, Dy, Ho, Er, Tm, Yb, Lu, Q=Y, Ca, Sr, Ba, Pr, Nd, Sm, Eu, Gd, Tb, Dy, Ho, Er, Tm, Yb, Lu such that the elements chosen for P and Q are different from each other; M=Sc, Ti, V, Cr, Mn, Fe, Co, Ni, Cu, Zn, Ga, Ge, Al and N═Sc, Ti, V, Cr, Mn, Fe, Co, Ni, Cu, Zn, Ga, Ge, Al such that the elements chosen for M and N are different from each other, with 0≦x≦1 and 0≦y≦1, preferably 0.25≦x≦0.55 and 0.25≦y≦0.55;

5) Zirconia based solid solutions:
ZrO₂-MO where M=Mg, Ca.
ZrO₂-M₂O₃ where M=Sc, Y, La, Pr, Nd, Sm, Eu, Gd, Tb, Dy, Ho, Er, Tm, Yb, Lu.
ZrO₂—Bi₂O₃-M₂O₃ where M=Sc, Y, La, Pr, Nd, Sm, Eu, Gd, Tb, Dy, Ho, Er, Tm, Yb, Lu.

6) Hafnia based solid solutions:
HfO₂-MO where M=Mg, Ca.
HfO₂-M₂O₃ where M=Sc, Y, La, Pr, Nd, Sm, Eu, Gd, Tb, Dy, Ho, Er, Tm, Yb, Lu.

7) Ceria based solid solutions:
CeO₂-MO where M=Mg, Ca, Sr.
CeO₂-M₂O₃ where M=Sc, Y, La, Pr, Nd, Sm, Eu, Gd, Tb, Dy, Ho, Er, Tm, Yb, Lu.

8) Thoria based solid solutions:
ThO₂-MO where M=Mg, Ca, Sr, Ba.
ThO₂-M₂O₃ where M=Sc, Y, La, Pr, Nd, Sm, Eu, Gd, Tb, Dy, Ho, Er, Tm, Yb, Lu.

9) Urania based solid solutions:
UO₂-MO where M=Mg, Ca, Sr, Ba.
UO₂-M₂O₃ where M=Sc, Y, La, Pr, Nd, Sm, Eu, Gd, Tb, Dy, Ho, Er, Tm, Yb, Lu.

10) Bismuth oxide based solid solutions:
Bi₂O₃-MO where M=Mg, Ca, Sr, Ba, Pb.
Bi₂O₃-M₂O₃ where M=Sc, Y, La, Pr, Nd, Sm, Eu, Gd, Tb, Dy, Ho, Er, Tm, Yb.
Bi₂O₃—WO₃.
Bi₂O₃.(PbO)₁₋ₓ.(CaO)ₓ, with 0≦x≦1, preferably 0.4≦x≦0.8.

11) Oxygen saturated fluorites:
CaF₂—CaO.
BaF₂—BaO
   and any mixtures thereof.

Preferred is the use of zirconia, preferably yttria stabilized zirconia and the use of a lanthanum based oxide, preferably LaMnO₃ or (LaSr)MnO₃. As indicated above, the material has to provide two functions, i.e. ion conductivity and electron conductivity. Therefore a mixture of two different materials is required for the SE of the present invention, although the materials may be selected from the same principle groups of materials. A preferred mixture is a mixture of zirconia, preferably yttria stabilized zirconia with a lanthanum based oxide, preferably LaMnO₃ or (LaSr)MnO₃.

Other preferred materials include lanthanum manganite (LaMnO₃), A-site strontium doped lanthanum manganite ((LaSr)MnO₃), lanthanum cobaltite (LaCoO₃), A-site strontium doped cobaltite ((LaSr)CoO₃), A-site strontium doped and B-site iron doped lanthanum cobaltite ((LaSr)CoFeO₃), yttria doped zirconia (YSZ), samaria doped ceria (SDC), or gadolinia doped ceria (GDC), and a mixture thereof.

Preparation methods of a sensing electrode of the present invention include powder mixing from the beginning of the electrode preparation, ion impregnation, and other techniques well-known to people skilled in this art. During the dispersion process, the particles within a sensing electrode of this invention are preferred to be dispersed in a fine way i.e. in a size below 200 nm, preferably less than 100 nm, by which the contacts between particles can be increased significantly and electrode activity can be improved.

A further surprising advantage of this way of preparing the SE is the fact that thereby a very finely dispersed structure of the binary mixture metal/metal oxide can be prepared in the matrix of the ion conductor/electron conductor.

A preferred method to prepare a sensing electrode of the present invention is to simply mix the particles from the beginning of electrode preparation. For example, to prepare a sensing electrode made of (LaSr)MnO₃ and YSZ, the fine particles of (LaSr)MnO₃ and YSZ are mixed by ball-milling and then the particles mixture of YSZ and (LaSr)MnO₃ are sintered at high temperatures such as 1100° C. to be prepared as a sensing electrode. By this simple method, particle sizes of (LaSr)MnO₃ and YSZ can be ca. 500 nm, preferably below 200 nm.

An also preferred method to prepare a sensing electrode of the present invention is the so-called ion impregnation. During the ion impregnation, solutions such as the nitrate solutions serving as the precursor of a target oxide are impregnated into an electrode, then appropriate heat treatments are carried out to decompose the precursor solution and form the finely dispersed target oxide particles afterwards within the entire electrode. For example, to create finely-dispersed samaria doped ceria particles within a sensing electrode where some other oxide particles such as (LaSr)MnO₃ and YSZ particles have located, the nitrate solution of samarium and gadolinium are impregnated into the previously locating oxide particles, then the electrode is heated at an elevated temperature such as 700° C., the nitrate solution of samarium and gadolinium are thus decomposed and the target oxides of samaria doped ceria is then formed and finely dispersed within the entire sensing electrode. By this method, particle sizes of samaria doped ceria particles can be less than 100 nm.

Typically it is possible in accordance with the present invention to provide a structure wherein the particle sizes of the material employed in the final electrode are in the range of less than 200 μm, preferably less than 100 μm, more preferably less than 50 μm. In embodiments it is possible to obtain particle sizes of below 10 μm, more preferable of below 2 μm and in particular it is preferred when at least one type of the particles (i.e. metal and/or metal oxide, and/or ion/electron conductor) has a particle size in the nano range, such as 100 nm or less, preferably 50 nm or less. In some embodiments the particle sizes of the material employed in the final electrode are in the range of less than 2 μm, preferably less than 1 μm, more preferably less than 500 nm. In embodiments it is possible to obtain particle sizes of below 200 nm, more preferable of below 100 nm. These particle sizes may be determined by a scanning electron microscope.

Again this enables a simple but reliable production of an electrode (in this case the SE) in any desired shape. These SEes already achieve the principle aims of the present invention. Since (further) dopants may be added after the manufacture of the principle structure of the SE (i.e. the SE may be formed by casting or printing a slurry of the principle components as described above, followed by drying and sintering, followed optionally by impregnation of the SE with a further additive, such as Ce(Sm)O₂, preferably in nano size) it is possible to tailor the properties of the SE. Using this type of preparation method it is possible to avoid subjecting such additional components to sintering conditions, thereby again providing simple but effective means for improving SE performance by adding components at a later stage which then remain finely dispersed within the SE structure. In particular these impregnation steps may be used for adding dopants and components of the SE composition which are then introduced into a principle structure of the SE in a finely dispersed state, so that after any (if required) conversion (for example of soluble precursor materials into the desired oxides etc.) small sized, preferably nano sized, components are present in the SE of the present invention, which improve properties of the SE of the present invention.

Further Options for the IRE/SE

The IRE as well as the SE of the present invention may comprise additional materials. For example it is possible to impregnate the IRE and/or the SE with further components, such as with precursors of further oxide materials (so that impregnation may be carried out using soluble salts, such as nitrates etc. which can be converted into the corresponding oxides by methods known to the skilled person, such as sintering etc. For example the IRE and/or the SE may be impregnated so that they contain after the respective conversion additional oxides, such as oxides based on fluorite structured materials, such as doped (for example with Sm₂O₂) or undoped ceria (CeO₂). Such additional materials may be used to further tailor the properties of the IRE and/or SE. Preferably the optional additional impregnation is carried out using materials or precursor materials (such as soluble salts, for example nitrate salts) for the electrode materials. For example, a SE structure may be impregnated with a component (or precursor thereof) relevant for the properties of the SE, such as doped ceria. By using an impregnation, the amount and distribution of this component (see FIG. 11) may be tailored, since impregnation methods in particular enable the easy and reproducible preparation of nanosized components—thereby overall properties (in relation to a SE impregnated with a precursor for Sm₂O₃ doped CeO₂, in particular polarization resistance), may be improved.

The Internal Reference Oxygen Sensor of the Present Invention

All embodiments described in association with a Figure or a specific aspect may also be employed for other embodiments, for example those described in connection with another Figure.

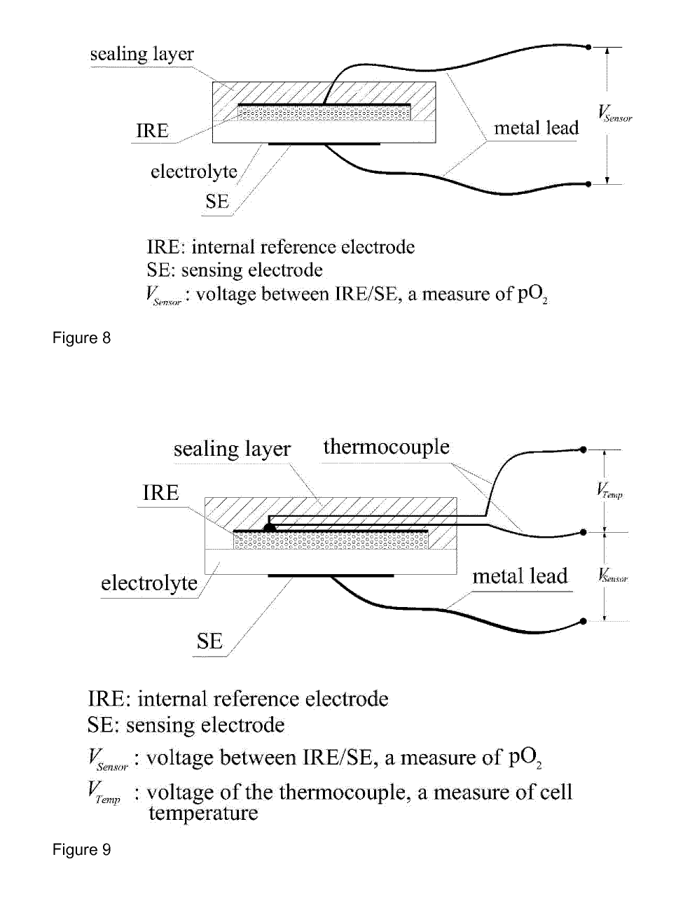

An internal reference oxygen sensor in accordance with the present invention comprises the IRE of the present invention, and an SE, which may be any conventional sensing electrode SE or the SE of the present invention. Preferably, an internal reference oxygen sensor of the present invention comprises a sensing electrode of the present invention. The IROS of the present invention may further comprise an electrolyte and a sealing layer that isolates the internal reference electrode from the environment. In particular when the IROS of the present invention comprises both the IRE as well as the SE of the present invention a highly advantageous system (IROS) is provided. As shown by the embodiment of FIGS. 8 to 10, an internal reference oxygen sensor of the present invention must have a sealing layer that is used to isolate the internal reference electrode from environment. The sealing layer can be made of glass, i.e. a mixture of alumina, silica and sodium oxide, or other oxide materials such as alumina, silica and magnesium oxide. As also known from FIGS. 8 to 10, an internal reference oxygen sensor of the present invention can be optionally equipped with a thermocouple that is used to detect sensor temperature, or with heaters that may be made of metals such as tungsten, platinum or molybdenum, or be made of oxides such as lanthanum strontium manganites. The heaters are used to heat the cell to the functional temperature.

Since all materials required for the IRE, the SE as well as the necessary electrolyte can be based on inorganic oxide materials manufacturing techniques known from other fields, such as ceramic materials, fuel cells etc. may be used, so that it is possible to employ established manufacturing processed. At the same time the desired IROS can be prepared using in particular printing processes (which enable the production of small sized IROS) and the obtained sensors are robust and mainly consist of rather inexpensive materials which are readily available. Thereby the drawbacks of the prior art can be overcome and the advantages described herein can be realized.

Suitable structures for an internal reference oxygen sensor in accordance with the present invention are shown in FIGS. 8 to 10 and they are discussed in the following.

FIG. 8 shows an embodiment of the internal reference oxygen sensor in accordance with the present invention. The sensor includes an internal reference electrode, an electrolyte and a sensing electrode connected by an electrolyte. In the sensor thereof the internal reference electrode is completely covered by a sealing layer. Such an internal reference oxygen sensor can measure the oxygen content in sample gas by determining the voltage between the internal reference electrode and the sensing electrode in a manner known to the person skilled in the art.

An electrolyte is required to provide oxide ion conduction between the internal reference electrode and the sensing electrode. Typical examples of suitable electrolyte material are known to the person skilled in the art and include oxide materials, such as stabilized zirconia or mixed oxides, such as stabilized ziconia with Sc₂O₃. Other examples include yttria stabilized zirconia, scandia stabilized zirconia, or a mixture thereof. However, the type of this electrolyte material is not critical as long as the required ion conductivity is provided; all conventional electrolyte materials may be employed. Further examples of suitable electrolyte materials include:

1) Zirconia based solid solutions:
ZrO₂-MO where M=Mg, Ca, Ba.
ZrO₂-M₂O₃ where M=Sc, Y, La, Pr, Nd, Sm, Eu, Gd, Tb, Dy, Ho, Er, Tm, Yb, Lu.
ZrO₂—Bi₂O₃-M₂O₃ where M=Sc, Y, La, Pr, Nd, Sm, Eu, Gd, Tb, Dy, Ho, Er, Tm, Yb, Lu.

2) Hafnia based solid solutions:
HfO₂-MO where M=Mg, Ca, Sr, Ba.
HfO₂-M₂O₃ where M=Sc, Y, La, Pr, Nd, Sm, Eu, Gd, Tb, Dy, Ho, Er, Tm, Yb, Lu.

3) Ceria based solid solutions:
CeO₂-MO where M=Mg, Ca, Sr, Ba.
CeO₂-M₂O₃ where M=Sc, Y, La, Pr, Nd, Sm, Eu, Gd, Tb, Dy, Ho, Er, Tm, Yb, Lu.

4) Thoria based solid solutions:
ThO₂-MO where M=Mg, Ca, Sr, Ba.
ThO₂-M₂O₃ where M=Sc, Y, La, Pr, Nd, Sm, Eu, Gd, Tb, Dy, Ho, Er, Tm, Yb, Lu.

5) Urania based solid solutions:
UO₂-MO where M=Mg, Ca, Sr, Ba.
UO₂-M₂O₃ where M=Sc, Y, La, Pr, Nd, Sm, Eu, Gd, Tb, Dy, Ho, Er, Tm, Yb, Lu.

6) Bismuth oxide based solid solutions:
Bi₂O₃-MO where M=Mg, Ca, Sr, Ba, Pb.
Bi₂O₃-M₂O₃ where M=Sc, Y, La, Pr, Nd, Sm, Eu, Gd, Tb, Dy, Ho, Er, Tm, Yb.
Bi₂O3—WO₃.
Bi₂O₃.(PbO)₁₋ₓ.(CaO)ₓ, with 0≦x≦1, preferably 0.4≦x≦0.8;

7) Oxygen saturated fluorites:
CaF₂—CaO.
BaF₂—BaO.
   and any mixtures thereof.

A sealing layer is required to isolate an internal reference electrode from surrounding atmosphere. Suitable sealing materials are ceramic materials as well as glasses, which provide the required protection of the IRE against the surrounding atmosphere, in particular oxygen. Hence, suitable sealing materials include materials made of glass, i.e. a mixture of alumina, silica and sodium oxide, or other oxide materials such as alumina, silica, stabilized zirconia and magnesium oxide. Suitable materials are known to the skilled person and may be selected depending the intended end use or in view of manufacturing process requirements. In particular when aiming at a miniaturization and/or mass production it is often advantageous if the material for the sealing layer may be applied in a similar manner, compared with the materials for the other parts of an internal reference oxygen sensor, such as by screen printing and tape casting methods etc.

Metal leads for an internal reference electrode and a sensing electrode are required in order to enable the determination of sensor voltage. These leads may be prepared from any suitable electrically conducting material including noble metals such as gold, silver, platinum, other metals such as copper, nickel, etc., steel or the alloys thereof. The material for these leads usually is not critical and again may be selected in view of the intended use of an internal reference oxygen sensor or in view of fabrication process requirements and/or costs.

FIG. 9 shows a similar exemplified structure compared with FIG. 8, only that the embodiment now additionally includes a thermocouple, which again may be selected among conventional thermocouples known to the skilled person. The advantage of providing a thermocouple is that a sensor employing this exemplified structure can measure simultaneously oxygen content and the sensor temperature, which improves the measurement accuracy.

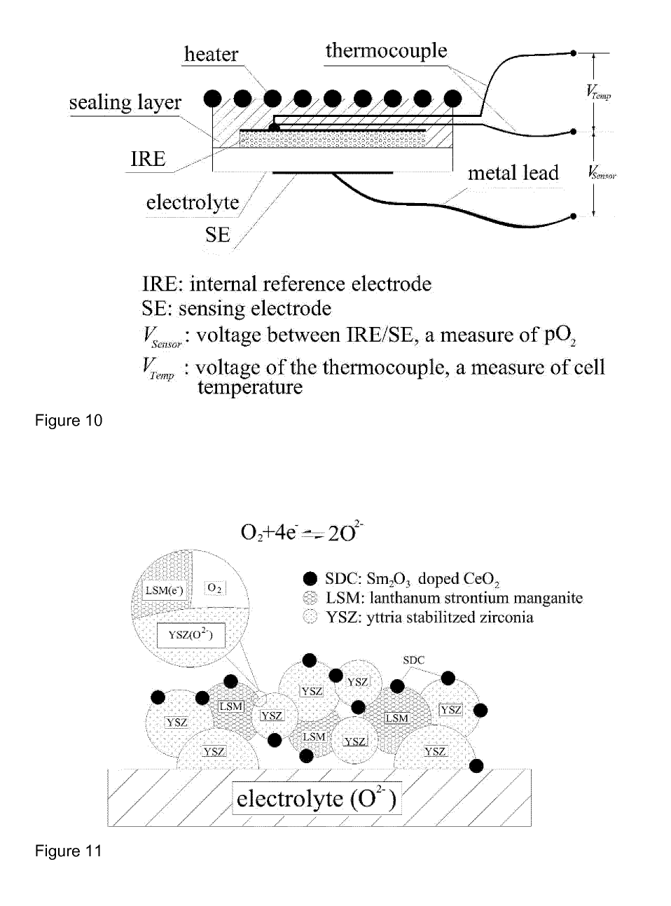

FIG. 10 shows an embodiment of the present invention where the IROS in addition to the IRE, the SE and the thermocouple also comprises heating elements, so that no external heating is required to bring the IROS to the required measurement temperature. This type of integrated heating elements further improves the uniformity of the temperature filed inside the IROS, compared with the use of an external heating element, which further improves the accuracy. The heaters may be made of materials well-known to people skilled in this art such as metals including tungsten, platinum or molybdenum, or alloys thereof, and oxides including lanthanum strontium manganites.

FIG. 13 illustrates the fabrication of a miniaturized internal reference oxygen sensor in accordance with the present invention. The fabrication methods include screen printing, physical vapour deposition, pulsed laser deposition, chemical vapour deposition and photolithography etc., which are already well known and in use in other fields, such as in the chip industry. In the fabrication of a miniaturized cell, a substrate that may be a silicon wafer is etched to provide a layered cavity. Then the required layers for the functionality can be deposited in order. An internal reference electrode, an electrolyte and a sensing electrode are deposited in sequence. Since the electrolyte layer may serve a dual function as a sealing layer as well as for providing oxide ion conductivity, the functionality of an internal reference oxygen sensor can be achieved with a very small overall thickness, such as 0.3 mm or less.

The IROS in accordance with the present invention may be employed in all fields where so far conventional oxygen sensors have been used. Since the IROS in accordance with the present invention is robust, can be prepared with a small size in a reliable manner even in high numbers it furthermore offers the option to broaden the field of use for such oxygen sensors where so far conventional sensors were too complicated to use or could for example not withstand the working conditions. Due to the decreased working temperature of the IROS in accordance with the present invention it is furthermore possible to employ the novel IROS in fields where so far the high working temperature of oxygen sensors prohibited their application.

Particular items of the present invention include:

Item 1: Composite internal reference electrode for an internal reference oxygen sensor comprising a binary mixture metal/metal oxide and a further material or material mixture providing ion conductivity and electron conductivity as electrode material.

Item 2: Composite internal reference electrode according to item 1, wherein the further material or material mixture providing ion and electron conductivity is selected among ceramic materials, and refractory oxides.

Item 3: Composite internal reference electrode according to items 1 or 2, wherein the further material or material mixture providing ion and electron conductivity is selected among

1) Undoped perovskites with general formula:
PMO₃ where P═La, Sr, and M=Sc, Ti, V, Cr, Mn, Fe, Co, Ni, Cu, Zn, Ga, Ge, Al.

2) Layered oxides with undoped perovskite-like structures with general formula:
P₂MO₄ where P═La, Sr and M=Sc, Ti, V, Cr, Mn, Fe, Co, Ni, Cu, Zn, Ga, Ge, Al.

3) A-site doped perovskites with general formula:
(P₁₋ₓOₓ)_{y}MO₃ where P═La, Y, Pr, Tb, Q=Ca, Sr, Ba, and M=Sc, Ti, V, Cr, Mn, Fe, Co, Ni, Cu, Zn, Ga, Ge, Al (with 0≦x≦1 and 0 y≦1, preferably 0.25≦x≦0.55 and 0.95≦y≦1).

4) A- and B-site doped perovskites with general formula:
(P₁₋ₓQₓ)M_{1-y}N_{y}O₃ where P═Y, Ca, Sr, Ba, Ce, Pr, Nd, Sm, Eu, Gd, Tb, Dy, Ho, Er, Tm, Yb, Lu, Q=Y, Ca, Sr, Ba, Pr, Nd, Sm, Eu, Gd, Tb, Dy, Ho, Er, Tm, Yb, Lu such that the elements chosen for P and Q are different from each other; M=Sc, Ti, V, Cr, Mn, Fe, Co, Ni, Cu, Zn, Ga, Ge, Al and N═Sc, Ti, V, Cr, Mn, Fe, Co, Ni, Cu, Zn, Ga, Ge, Al such that the elements chosen for M and N are different from each other, with 0≦x≦1 and 0≦y≦1, preferably 0.25≦x≦0.55 and 0.25≦y≦0.55;

5) Zirconia based solid solutions:
ZrO₂-MO where M=Mg, Ca.
ZrO₂-M₂O₃ where M=Sc, Y, La, Pr, Nd, Sm, Eu, Gd, Tb, Dy, Ho, Er, Tm, Yb, Lu.
ZrO₂—Bi₂O₃—M₂O₃ where M=Sc, Y, La, Pr, Nd, Sm, Eu, Gd, Tb, Dy, Ho, Er, Tm, Yb, Lu.

6) Hafnia based solid solutions:
HfO₂-MO where M=Mg, Ca.
HfO₂-M₂O₃ where M=Sc, Y, La, Pr, Nd, Sm, Eu, Gd, Tb, Dy, Ho, Er, Tm, Yb, Lu.

7) Ceria based solid solutions:
CeO₂-MO where M=Mg, Ca, Sr.
CeO₂-M₂O₃ where M=Sc, Y, La, Pr, Nd, Sm, Eu, Gd, Tb, Dy, Ho, Er, Tm, Yb, Lu.

8) Thoria based solid solutions:
ThO₂-MO where M=Mg, Ca, Sr, Ba.
ThO₂-M₂O₃ where M=Sc, Y, La, Pr, Nd, Sm, Eu, Gd, Tb, Dy, Ho, Er, Tm, Yb, Lu.

9) Urania based solid solutions:
UO₂-MO where M=Mg, Ca, Sr, Ba.
UO₂-M₂O₃ where M=Sc, Y, La, Pr, Nd, Sm, Eu, Gd, Tb, Dy, Ho, Er, Tm, Yb, Lu.

10) Bismuth oxide based solid solutions:
Bi₂O₃-MO where M=Mg, Ca, Sr, Ba, Pb.
Bi₂O₃-M₂O₃ where M=Sc, Y, La, Pr, Nd, Sm, Eu, Gd, Tb, Dy, Ho, Er, Tm, Yb.
Bi₂O₃—WO₃.
Bi₂O₃.(PbO)₁₋ₓ.(CaO)ₓ, with 0≦x≦1, preferably 0.4≦x≦0.8.

11) Oxygen saturated fluorites:
CaF₂—CaO.
BaF₂—BaO.

Item 4: Composite internal reference electrode according to any one of items 1 to 3, wherein the binary mixture metal/metal oxide is selected among nickel/nickel oxide, palladium/palladium oxide, iron/iron oxide, cobalt/cobalt oxide, copper/copper oxide, tungsten/tungsten oxide, titanium/titanium oxide, vanadium/vanadium oxide, chromium/chromium oxide, manganese/manganese oxide, zinc/zinc oxide, niobium/niobium oxide, molybdenum/molybdenum oxide, ruthenium/ruthenium oxide, rhodium/rhodium oxide, silver/silver oxide, cadmium/cadmium oxide, indium/indium oxide, tin/tin oxide, antimony/antimony oxide, tellurium/tellurium oxide, tantalum/tantalum oxide, rhenium/rhenium oxide, osmium/osmium oxide, iridium/iridium oxide, platinum/platinum oxide, thallium/thallium oxide, lead/lead oxide, preferably among nickel and nickel oxide, cobalt and cobalt oxide, iron and iron oxide, as well as rhodium and rhodium oxide.

Item 5: Composite internal reference electrode according to any one of items 1 to 4, obtained by mixing the further material or material mixture providing ion and electron conductivity with the metal oxide of the binary mixture metal/metal oxide, wherein the metal of the binary mixture metal/metal oxide is prepared after formation of the principle internal reference electrode structure by electrochemical reduction of the metal oxide.

Item 6: Composite sensing electrode for an internal reference oxygen sensor comprising a material or material mixture providing ion conductivity and electron conductivity.

Item 7: Composite sensing electrode according to item 6, wherein the material providing ion conductivity is selected among ceramic materials and refractory oxides.

Item 8: Composite sensing electrode according to items 6 or 7, wherein the material providing ion conductivity is selected among

1) Undoped perovskites with general formula:
PMO₃ where P═La, Sr, and M=Sc, Ti, V, Cr, Mn, Fe, Co, Ni, Cu, Zn, Ga, Ge, Al.

2) Layered oxides with undoped perovskite-like structures with general formula:
P₂MO₄ where P═La, Sr and M=Sc, Ti, V, Cr, Mn, Fe, Co, Ni, Cu, Zn, Ga, Ge, Al.

3) A-site doped perovskites with general formula:
(P₁₋ₓOₓ)_{y}MO₃ where P═La, Y, Pr, Tb, Q=Ca, Sr, Ba, and M=Sc, Ti, V, Cr, Mn, Fe, Co, Ni, Cu, Zn, Ga, Ge, Al (with 0≦x≦1 and 0 y≦1, preferably 0.25≦x≦0.55 and 0.95≦y≦1).

4) A- and B-site doped perovskites with general formula:
(P₁₋ₓQₓ)M_{1-y}N_{y}O₃ where P═Y, Ca, Sr, Ba, Ce, Pr, Nd, Sm, Eu, Gd, Tb, Dy, Ho, Er, Tm, Yb, Lu, Q=Y, Ca, Sr, Ba, Pr, Nd, Sm, Eu, Gd, Tb, Dy, Ho, Er, Tm, Yb, Lu such that the elements chosen for P and Q are different from each other; M=Sc, Ti, V, Cr, Mn, Fe, Co, Ni, Cu, Zn, Ga, Ge, Al and N═Sc, Ti, V, Cr, Mn, Fe, Co, Ni, Cu, Zn, Ga, Ge, Al such that the elements chosen for M and N are different from each other, with 0≦x≦1 and 0≦y≦1, preferably 0.25≦x≦0.55 and 0.25≦y≦0.55;

5) Zirconia based solid solutions:
ZrO₂-MO where M=Mg, Ca.
ZrO₂-M₂O₃ where M=Sc, Y, La, Pr, Nd, Sm, Eu, Gd, Tb, Dy, Ho, Er, Tm, Yb, Lu.
ZrO₂—Bi₂O₃-M₂O₃ where M=Sc, Y, La, Pr, Nd, Sm, Eu, Gd, Tb, Dy, Ho, Er, Tm, Yb, Lu.

6) Hafnia based solid solutions:
HfO₂-MO where M=Mg, Ca.
HfO₂-M₂O₃ where M=Sc, Y, La, Pr, Nd, Sm, Eu, Gd, Tb, Dy, Ho, Er, Tm, Yb, Lu.

7) Ceria based solid solutions:
CeO₂-MO where M=Mg, Ca, Sr.
CeO₂-M₂O₃ where M=Sc, Y, La, Pr, Nd, Sm, Eu, Gd, Tb, Dy, Ho, Er, Tm, Yb, Lu.

8) Thoria based solid solutions:
ThO₂-MO where M=Mg, Ca, Sr, Ba.
ThO₂-M₂O₃ where M=Sc, Y, La, Pr, Nd, Sm, Eu, Gd, Tb, Dy, Ho, Er, Tm, Yb, Lu.

9) Urania based solid solutions:
UO₂-MO where M=Mg, Ca, Sr, Ba.
UO₂-M₂O₃ where M=Sc, Y, La, Pr, Nd, Sm, Eu, Gd, Tb, Dy, Ho, Er, Tm, Yb, Lu.

10) Bismuth oxide based solid solutions:
Bi₂O₃-MO where M=Mg, Ca, Sr, Ba, Pb.
Bi₂O₃-M₂O₃ where M=Sc, Y, La, Pr, Nd, Sm, Eu, Gd, Tb, Dy, Ho, Er, Tm, Yb.
Bi₂O₃—WO₃.
Bi₂O₃.(PbO)₁₋ₓ.(CaO)ₓ, with 0≦x≦1, preferably 0.4≦x≦0.8.

11) Oxygen saturated fluorites:
CaF₂—CaO.
BaF₂—BaO
   preferably wherein the material providing ion conductivity is selected among optionally doped LaMnO₃, LaCoO₃, (La, Sr)MnO₃, ZrO₂, and CeO₂, more preferably yttria stabilized zirconia and lanthanides based oxides, wherein the lanthanides preferably are selected among Ce, Pr, Nd, Sm, Eu, Gd, Tb, Dy, Ho, Er, Tm, Yb, Lu.

Item 9: Composite sensing electrode according to item 6, wherein the material providing electron conductivity is selected among ceramic materials and refractory oxides.

Item 10: Composite sensing electrode according to items 6 and/or 9, wherein the material providing electron conductivity is selected among

1) Undoped perovskites with general formula:
PMO₃ where P═La, Sr, and M=Sc, Ti, V, Cr, Mn, Fe, Co, Ni, Cu, Zn, Ga, Ge, Al.

2) Layered oxides with undoped perovskite-like structures with general formula:
P₂MO₄ where P═La, Sr and M=Sc, Ti, V, Cr, Mn, Fe, Co, Ni, Cu, Zn, Ga, Ge, Al.

3) A-site doped perovskites with general formula:
(P₁₋ₓQₓ)_{y}MO₃ where P═La, Y, Pr, Tb, Q=Ca, Sr, Ba, and M=Sc, Ti, V, Cr, Mn, Fe, Co, Ni, Cu, Zn, Ga, Ge, Al (with 0≦x≦1 and 0 y≦1, preferably 0.25≦x≦0.55 and 0.95≦y≦1).

4) A- and B-site doped perovskites with general formula:
(P₁₋ₓQₓ)M_{1-y}N_{y}O₃ where P═Y, Ca, Sr, Ba, Ce, Pr, Nd, Sm, Eu, Gd, Tb, Dy, Ho, Er, Tm, Yb, Lu, Q=Y, Ca, Sr, Ba, Pr, Nd, Sm, Eu, Gd, Tb, Dy, Ho, Er, Tm, Yb, Lu such that the elements chosen for P and Q are different from each other; M=Sc, Ti, V, Cr, Mn, Fe, Co, Ni, Cu, Zn, Ga, Ge, Al and N═Sc, Ti, V, Cr, Mn, Fe, Co, Ni, Cu, Zn, Ga, Ge, Al such that the elements chosen for M and N are different from each other, with 0≦x≦1 and 0≦y≦1, preferably 0.25≦x≦0.55 and 0.25≦y≦0.55;

5) Zirconia based solid solutions:
ZrO₂-MO where M=Mg, Ca.
ZrO₂-M₂O₃ where M=Sc, Y, La, Pr, Nd, Sm, Eu, Gd, Tb, Dy, Ho, Er, Tm, Yb, Lu.
ZrO₂—Bi₂O₃-M₂O₃ where M=Sc, Y, La, Pr, Nd, Sm, Eu, Gd, Tb, Dy, Ho, Er, Tm, Yb, Lu.

6) Hafnia based solid solutions:
HfO₂-MO where M=Mg, Ca.
HfO₂-M₂O₃ where M=Sc, Y, La, Pr, Nd, Sm, Eu, Gd, Tb, Dy, Ho, Er, Tm, Yb, Lu.

7) Ceria based solid solutions:
CeO₂-MO where M=Mg, Ca, Sr.
CeO₂-M₂O₃ where M=Sc, Y, La, Pr, Nd, Sm, Eu, Gd, Tb, Dy, Ho, Er, Tm, Yb, Lu.

8) Thoria based solid solutions:
ThO₂-MO where M=Mg, Ca, Sr, Ba.
ThO₂-M₂O₃ where M=Sc, Y, La, Pr, Nd, Sm, Eu, Gd, Tb, Dy, Ho, Er, Tm, Yb, Lu.

9) Urania based solid solutions:
UO₂-MO where M=Mg, Ca, Sr, Ba.
UO₂-M₂O₃ where M=Sc, Y, La, Pr, Nd, Sm, Eu, Gd, Tb, Dy, Ho, Er, Tm, Yb, Lu.

10) Bismuth oxide based solid solutions:
Bi₂O₃-MO where M=Mg, Ca, Sr, Ba, Pb.
Bi₂O₃-M₂O₃ where M=Sc, Y, La, Pr, Nd, Sm, Eu, Gd, Tb, Dy, Ho, Er, Tm, Yb.
Bi₂O₃—WO₃.
Bi₂O₃.(PbO)₁₋ₓ.(CaO)ₓ, with 0≦x≦1, preferably 0.4≦x≦0.8.

11) Oxygen saturated fluorites:
CaF₂—CaO.
BaF₂—BaO
   preferably wherein the material providing electron conductivity is selected among optionally doped LaMnO₃, LaCoO₃, (La, Sr)MnO₃, ZrO₂, and CeO₂, more preferably yttria stabilized zirconia and lanthanides based oxides, wherein the lanthanides preferably are selected among Ce, Pr, Nd, Sm, Eu, Gd, Tb, Dy, Ho, Er, Tm, Yb, Lu.

Item 11: Composite sensing electrode according to any one of items 6 to 10 comprising a mixture of yttria stabilized zirconia with (La, Sr)MnO₃.

Item 12: Internal reference oxygen sensor comprising the internal reference electrode according to any one of items 1 to 5 and/or the sensing electrode according to any one of items 6 to 11.

Item 13: Internal reference oxygen sensor according to item 12, comprising further an electrolyte selected among

1) Zirconia based solid solutions:
ZrO₂-MO where M=Mg, Ca, Ba.
ZrO₂-M₂O₃ where M=Sc, Y, La, Pr, Nd, Sm, Eu, Gd, Tb, Dy, Ho, Er, Tm, Yb, Lu.
ZrO₂-Bi₂O₃-M₂O₃ where M=Sc, Y, La, Pr, Nd, Sm, Eu, Gd, Tb, Dy, Ho, Er, Tm, Yb, Lu.

2) Hafnia based solid solutions:
HfO₂-MO where M=Mg, Ca, Sr, Ba.
HfO₂-M₂O₃ where M=Sc, Y, La, Pr, Nd, Sm, Eu, Gd, Tb, Dy, Ho, Er, Tm, Yb, Lu.

3) Ceria based solid solutions:
CeO₂-MO where M=Mg, Ca, Sr, Ba.
CeO₂-M₂O₃ where M=Sc, Y, La, Pr, Nd, Sm, Eu, Gd, Tb, Dy, Ho, Er, Tm, Yb, Lu.

4) Thoria based solid solutions:
ThO₂-MO where M=Mg, Ca, Sr, Ba.
ThO₂-M₂O₃ where M=Sc, Y, La, Pr, Nd, Sm, Eu, Gd, Tb, Dy, Ho, Er, Tm, Yb, Lu.

5) Urania based solid solutions:
UO₂-MO where M=Mg, Ca, Sr, Ba.
UO₂-M₂O₃ where M=Sc, Y, La, Pr, Nd, Sm, Eu, Gd, Tb, Dy, Ho, Er, Tm, Yb, Lu.

6) Bismuth oxide based solid solutions:
Bi₂O₃-MO where M=Mg, Ca, Sr, Ba, Pb.
Bi₂O₃-M₂O₃ where M=Sc, Y, La, Pr, Nd, Sm, Eu, Gd, Tb, Dy, Ho, Er, Tm, Yb.
Bi₂O3—WO₃.
Bi₂O₃.(PbO)₁₋ₓ.(CaO)ₓ, with 0≦x≦1, preferably 0.4≦x≦0.8;

7) Oxygen saturated fluorites:
CaF₂—CaO.
BaF₂—BaO.

The following examples further illustrate the present invention.

### EXAMPLES

IROSes were prepared comprising an internal reference electrode (IRE), an electrolyte, a sensing electrode (SE) and a sealing layer. The IRE was made from NiO (Alfa Aesar) and 8 mol % yttria stabilized zirconia (8YSZ) from Tosoh. Both powders contained a calcined part and an uncalcined part. Calcination of 8YSZ was performed at 1100° C. for 2 hours and calcination of NiO was performed at 800° C. for 3 hours. NiO, calcined NiO, 8YSZ and calcined 8YSZ powders, with a weight ratio of 3:3:2:2 were ball-mill mixed and made into an ink with a terpineol based solvent. The ink was screen-printed on 10×10 mm² ScYSZ (10 mol % Sc₂O₃ and 1 mol % Y₂O₃ stabilized zirconia, Daiichi) or 8YSZ tapes. The screen printed IRE was sintered at 1350° C. in air for 2 hours and the mass of the IRE was found from the weight gain after the IRE preparation.

Fabrication of the composite sensing electrodes started from an ink containing equal amounts of LSM25 _{[}(La_{0.75}Sr_{0.25})_{0.95}MnO_{3±δ}] and 8YSZ. Graphite (Aldrich), used as pore former, was added into the ink with a weight ratio of 20%. The ink was screen printed onto the electrolyte side opposite to the IRE and sintered at 1050° C. for 2 hours. Pt was also used as the SE in some cells to compare cell performance. The Pt electrode was prepared by brushing Pt paste (FERRO) on the side opposite to the IRE, and then heated to 1050° C. for 2 hours. The average electrode area was 0.25 cm².

Some IRE and/or SE were impregnated with SDC20 (10 mol % Sm₂O₃ doped CeO₂, Ce_{0.8}Sm_{0.2}O_{1.9}). The impregnation was performed by dripping a nitrate solution on the electrode (IRE and/or SE) surface and then decomposing the nitrate at 700° C. for 2 hours. The nitrate solution that consists of 1 M, 20 mol % Sm(NO₃)₃ with 80 mol % Ce(NO₃)₃[Ce_{0.8}Sm_{0.2}(NO₃)ₓ)], was prepared from Sm(NO₃)₃.6H₂O (Alfa Aesar) and Ce(NO₃)₃.6H₂O (Alfa Aesar). Four times impregnation of SDC20 resulted in a load of ca. 6 mg·cm⁻² for the IRE and ca. 3 mg·cm⁻² for the SE.

Some IRE had a gold coating that was applied by magnetron sputtering in argon under a pressure of 50 mTorr. The discharge voltage and current were 390 V and 400 mA, respectively, and the sputtering time was 1 hour. A Pt lead, used for connection between IRE and the external circuit was adhered to IRE by Pt paste, followed by a heat treatment at 700° C. for 1 hour. After electrode preparation, SDC impregnation and Pt lead connection, the glass sealing was applied. A silica based glass powder was mixed with a polyethelenglycol-containing solution and the resulting slurry was used to cover the IRE. The organics in the slurry decomposed in the glass sintering process, which was carried out at 960° C. for 2 hours to form a hermetic seal. The cooling rate from 960° C. was 2° C. per minute.

The cells were placed in an alumina experimental setup for accuracy test. The setup has an inner diameter of 69 mm and a length of 495 mm, and room for four samples to be tested in one batch. For the long term stability test, the cells were placed in a smaller quartz tube with an inner diameter of 25 mm and a length of 290 mm. The larger alumina and the smaller quartz setups can maintain a pO₂ as low as 7×10⁻³ and 2×10⁻² atm, respectively. The response time tests were carried out in the both setups. The atmosphere in all tests was controlled by mass flow controllers and the source gas species included air, oxygen and nitrogen. The minimum and maximum flow rates of the mass flow controllers were 0.1 and 6 L·h⁻¹, respectively.

Before an IROS becomes functional, its IRE needs to be partially electrochemically reduced to form the binary mixture of Ni and NiO. Voltage sweep tests were performed on the cells with an unreduced IRE in order to find the appropriate voltage for NiO reduction. The IRE reduction and voltage sweep were carried out at 664° C. and in air. If nothing else is mentioned below, the cells with Pt as SE were reduced at 1.1 V (the SE potential is positive), and the cells with ceramic sensing electrode (CSE) were reduced at 0.9 V, and the reduction time was 65 minutes. Chronoamperometry was carried out during reduction and from the curve of current vs. time the amount of reduced NiO can be determined.

The microstructure and chemical composition of the cells were investigated in a Zeiss Supra 35 field emission gun scanning electron microscope, equipped with a Noran System Six Model 3000 energy dispersive X-ray spectrometer, after sample polishing. The voltage sweeps, electrochemical impedance spectroscopy (EIS) and chronoamperometry were performed by a Solartron 1250 frequency response analyser along with a Solartron SI 1287 electrochemical interface. The EIS was performed with a bias voltage equal to the voltage of the cell being tested. By this means, the obtained impedance spectra were reproducible and the EIS would not damage the cell being tested. In the accuracy tests, cell voltages were read by a Keithley 2700 multimeter and the stabilization period for a new test condition, i.e., pO₂ or temperature was at least 2 hours. The accuracy of Keithley 2700 in the voltage range of 1V is ±(25 ppm of reading+7 ppm of range). In the response time tests, the nitrogen gas flow rate was kept at 4 L·h⁻¹ while the flow rate of oxygen varied between 0.1 and 1 L·h⁻¹. A Keithley 2700 and a Keithley KUSB-3108 were employed for the tests in the larger alumina setup and the smaller quartz test setup, respectively. In the smaller setup, the response time of cells was much shorter than that in the larger setup and Keithley KUSB-3108, possessing a much higher recording frequency (≧1 Hz) and an accuracy of 0.01% at a gain of 1 can record the voltage change in the course of gas switching.

Appearance and Structure of IROS

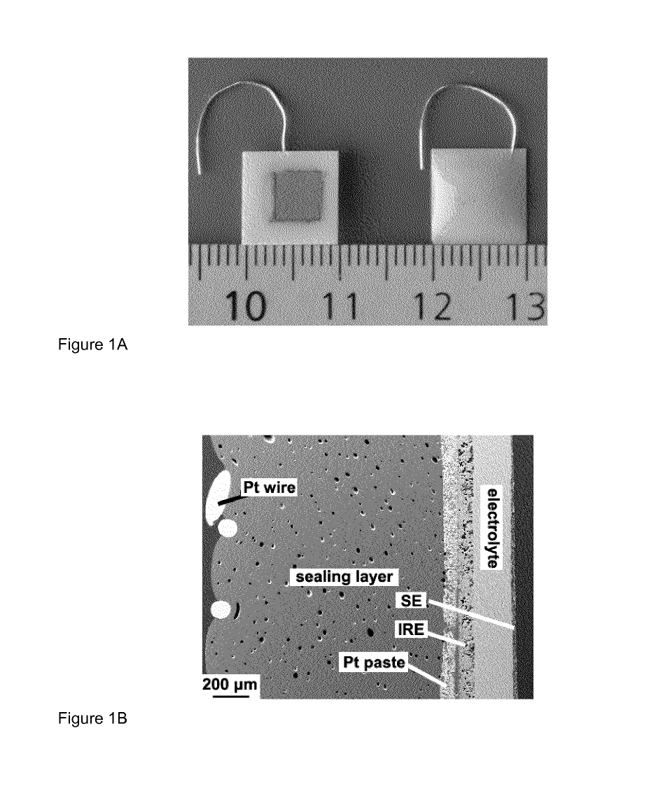

FIG. 1A and FIG. 1B show the size and appearance of an IROS and a SEM image of the polished cross section of a tested cell, respectively. The structure of the cell of (B) was IRE/ScYSZ/CSE. Since Pt paste and sealing layers outside the IRE were used in all cells, they are left out in cell structure notation for simplicity. The bubbles in the sealing layer did not connect to each other, meaning the sealing was hermetic.

Appropriate Reduction Voltage of NiO

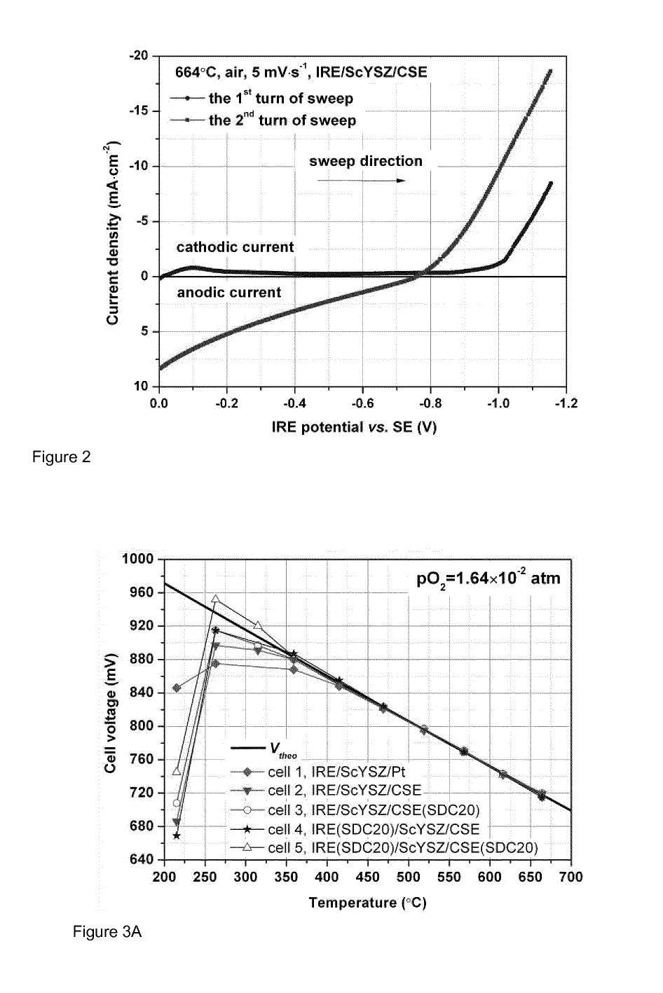

To find an appropriate voltage for NiO reduction, potential sweep tests were performed on cells with unreduced IRE. FIG. 2 shows results of voltage sweeps on an IROS with structure IRE/ScYSZ/CSE. It is known that polarization resistance of an LSM25-8YSZ electrode of this type in air is relatively low, around 0.8 Ω·cm² at 650° C., compared to a typical area specific resistance (ASR) of the whole IROS about 35 Ω·cm² under the identical condition. This means that the SE potential may be taken as approximately constant, and the voltage sweep may then be regarded as a potential sweep of the IRE including electrolyte with SE/air as a pseudo reference electrode. The potential sweeps, with a rate of 5 mV·s⁻¹, were cyclically performed between 0 and −2.0V for four times, but only the sections between 0 to −1.15 V of the first and the second sweeps were presented here for clarity, and the events taking place below −1.15 V vs. air has for this context only the effect of reducing more NiO, i.e., forming more and bigger Ni metal particles. The sweep curves became almost identical after the first sweep. A small peak occurred at ca. −100 mV during the first sweep but it did not reappear in the second sweep. After the small peak, the current density started to increase numerically from ca. −850 mV and the increase became significantly higher from ca. −1.0 V. After the first sweep, the IRE had a potential of ca. −770 mV vs. air, which made the current anodic when the second sweep started from 0 V vs. air. In the second sweep, the current changed from anodic to cathodic at ca. −770 mV and then showed a significant increase, with a slope approximately the same as that in the first sweep as below −1050 mV.

Cell Voltage Measurements

The theoretical cell voltage, Vₜₕₑₒ, of a potentiometric oxygen sensor can be calculated by the Nernst equation:

$${V}_{theo} = \frac{R T}{4 F} ln \frac{{p}_{I I}}{{p}_{I}} \qquad ( 1 )$$

where R is the gas constant, T is the temperature in Kelvin, F is Faraday's number, p_{II} is the sample pO₂ and p_{I} is the reference pO₂. In IROS, the reference pO₂, p_{I}, is given by:

$$ln {p}_{1} = - \frac{2 {Δ}_{r} {G}^{0}}{R T} \qquad ( 2 )$$

where ΔᵣG⁰ is the standard Gibbs free energy of reaction of NiO reduction:

NiO(s) [symbol] Ni(s)+1/2O₂(g) (3)

The measured cell voltage, V_{cell}, of an IROS may deviate from the theoretical voltage, Vₜₕₑₒ. As the theoretical voltage is taken as the correct voltage the error (ε) is defined in this article by:

$$ɛ = \frac{{V}_{cell} - {V}_{theo}}{{V}_{theo}} \times 100 \% \qquad ( 4 )$$

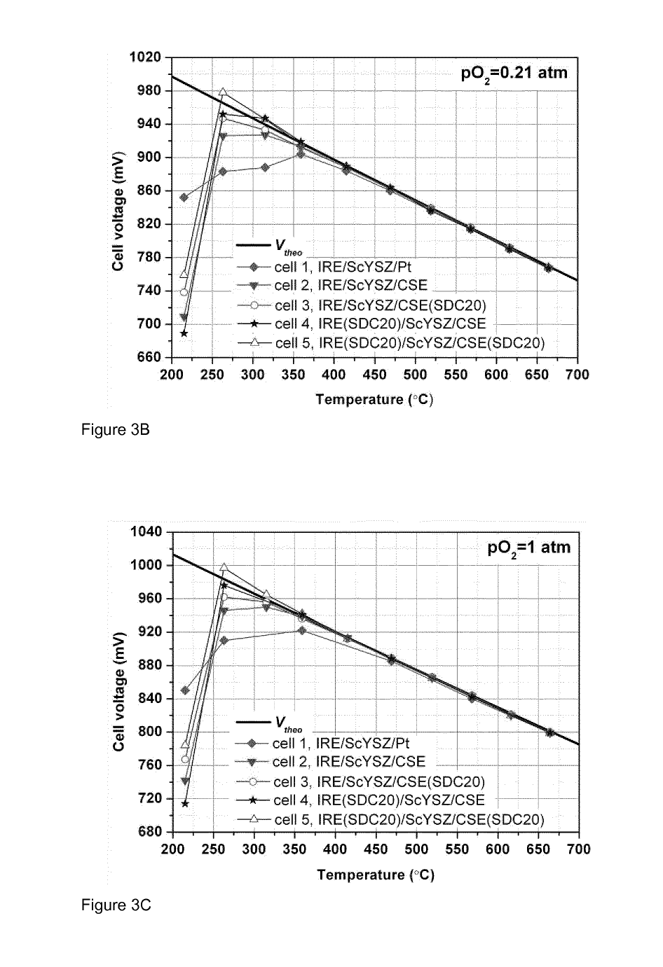

The graphs below, FIG. 3A, FIG. 3B and FIG. 3C, show the measured cell voltage, V_{cell}, of 5 IROS types with different details in the cell design for three pO₂ levels, 1.64×10⁻², 0.21 and 1 atm, in a temperature range of 210-664° C. The graphs also give the theoretical cell voltage, Vₜₕₑₒ. The ‘(SDC20)’ right to the electrode in cell structure notations means that the electrode has SDC20 impregnation. Table 1 lists the cell voltages and deviations from the theoretical voltage, i.e., the errors relative to Vₜₕₑₒ, at three temperatures (263° C., 469° C. and 664° C.) for all five cells. Above 450° C. V_{cell} agreed with Vₜₕₑₒ very well and the errors (ε) were less than 1%. Even at low temperature such as 263° C., cell 5 with SDC20 impregnated into the both electrodes, was able to work with ε<2%. The graphs show that V_{cell} is significantly lower than Vₜₕₑₒ at temperatures below 260° C. Therefore 260° C. is the suggested lowest reliable operation temperature for the cells presented here unless the cell voltage is calibrated against gases with well-known oxygen partial pressures. The sensing electrode of cell 1 was made of platinum and this cell showed definitely lower accuracy and higher functional temperature than other cells having a sensing electrode based on the oxides of LSM25, 8YSZ and SDC20.

The IROS with composite ceramic electrodes show advantages over the one with Pt electrode, especially in the aspects of an extended working temperature range and smaller errors. As shown below, cell 1, equipped with a Pt SE, had a lower voltage in the low temperature range of 260-450° C. for the three pO₂ levels. Even at a temperature above 450° C., the voltage of cell 1 was still slightly lower than that of cell 5 whose ceramic electrodes (IRE and SE) were impregnated by SDC20, as listed in Table 1. Among the cells with CSE, cells with SDC20 impregnated electrode(s) had the lowest error below 400° C. Taking cell 3-5 as examples, they had at least one electrode impregnated by SDC20 and gave lower error than cell 2 did when the temperature was below 400° C.

TABLE 1

| | | pO₂ = 0.0164 atm | | | pO₂ = 0.21 atm | | | pO₂ = 1 atm | | |
|---|---|---|---|---|---|---|---|---|---|---|
| Temp. | Cell | Vₜₕₑₒ | V_{cell} | ε | Vₜₕₑₒ | V_{cell} | ε | Vₜₕₑₒ | V_{cell} | ε |
| (° C.) | No. | (mV) | (mV) | (%) | (mV) | (mV) | (%) | (mV) | (mV) | (%) |
| 263 | 1 | 936 | 875 ± 7 | −6.5 | 965 | 883 ± 10 | −8.5 | 983 | 910 ± 6 | −7.4 |
| | 2 | | 897 ± 14 | −4.2 | | 926 ± 9 | −4.0 | | 946 ± 5 | −3.8 |
| | 3 | | 915 ± 7 | −2.2 | | 947 ± 5 | −1.9 | | 962 ± 4 | −2.1 |
| | 4 | | 915 ± 8 | −2.2 | | 952 ± 6 | −1.3 | | 976 ± 5 | −0.7 |
| | 5 | | 952 ± 6 | 1.7 | | 978 ± 8 | 1.3 | | 997 ± 11 | 1.4 |
| 469 | 1 | 823 | 821 ± 1 | −0.2 | 864 | 860 ± 1 | −0.5 | 889 | 885 ± 1 | −0.4 |
| | 2 | | 821 ± 1 | −0.2 | | 862 ± 1 | −0.2 | | 887 ± 1 | −0.2 |
| | 3 | | 823 ± 1 | 0 | | 863 ± 1 | −0.1 | | 889 ± 1 | 0 |
| | 4 | | 824 ± 1 | 0.1 | | 864 ± 1 | 0 | | 888 ± 1 | −0.1 |
| | 5 | | 822 ± 1 | −0.1 | | 862 ± 1 | −0.2 | | 888 ± 1 | −0.1 |
| 664 | 1 | 718 | 715 ± 1 | −0.4 | 770 | 767 ± 1 | −0.4 | 801 | 799 ± 1 | −0.2 |
| | 2 | | 719 ± 1 | 0.1 | | 767 ± 1 | −0.4 | | 799 ± 1 | −0.2 |
| | 3 | | 720 ± 1 | 0.3 | | 768 ± 1 | −0.3 | | 800 ± 1 | −0.1 |
| | 4 | | 715 ± 1 | −0.4 | | 767 ± 1 | −0.4 | | 799 ± 1 | −0.2 |
| | 5 | | 718 ± 1 | 0 | | 768 ± 1 | −0.3 | | 799 ± 1 | −0.2 |

Response Time

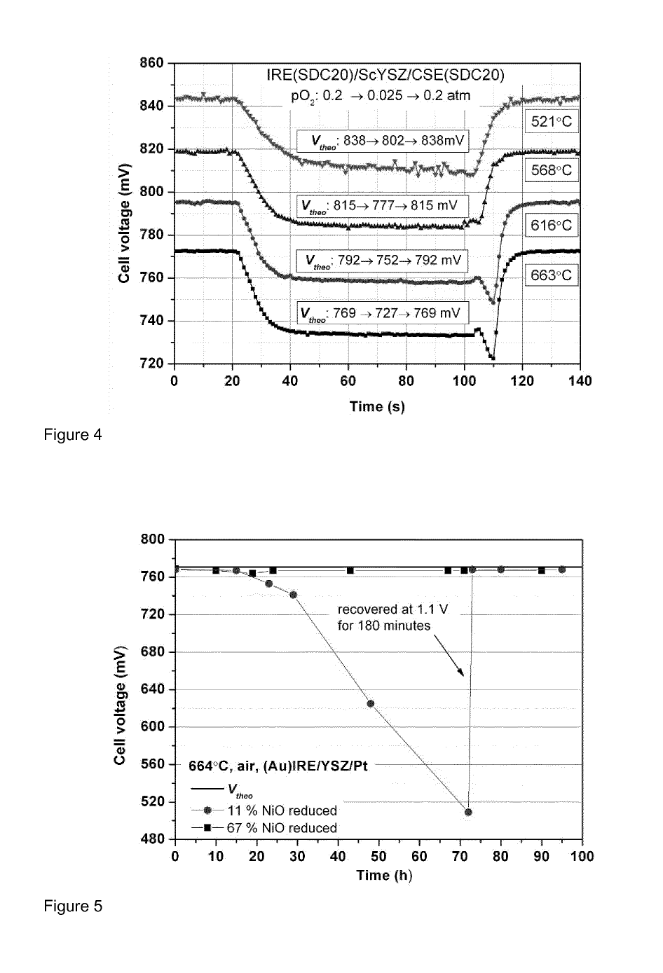

The response time of the cells were examined by switching gas while recording the cell voltage (V_{cell}). The graph below, FIG. 4, shows cell voltage variations in a pO₂ cycling at 521° C., 568° C., 616° C. and 663° C., respectively. The tests were carried out in the smaller quartz setup. During the cycling, pO₂ varied between 0.025 and 0.2 atm. As indicated, the cell responded to pO₂ variations quickly. It is found that: 1) response time depends on direction of pO₂ change. Changing pO₂ from high to low takes longer time than the inverse process. For example, upon changing the pO₂ from 0.2 to 0.025 atm it took ca. 30 seconds at 663° C. to reach a stable cell voltage, whereas the cell voltage stabilized within 15 seconds when the pO₂ was changed from 0.025 to 0.2 atm; 2) response time depends on temperature. Higher temperature makes the response time shorter. For example, when changing the pO₂ from 0.2 to 0.025 atm it took ca. 45 seconds at 521° C. to reach the stable voltage, whereas it took ca. 30 seconds at 663° C. The theoretical cell responses are given and the measured cell voltages were a bit higher than the theoretical values, especially under the low pO₂ condition. As mentioned above, the small quartz setup used for the response time tests had a small leak, and thus the relative errors at 0.025 atm in this setup were bigger than at 0.2 atm. Extra dips in cell voltage were seen when gas switching back to 0.2 atm pO₂, which might be caused by the process of flow rate adjustments of the oxygen mass flow controller. The dips were more obvious at high temperatures, i.e., 663° C. and 616° C. since the IROS responded to pO₂ variation faster at high temperature.

Stability, Recoverability and Thermal Cycling

Due to leaks and the very low but finite electronic conductivity of an electrolyte, the metallic constituent of a binary mixture will eventually be oxidized and exhausted in the long run, if the oxygen partial pressure in the sample gas is much higher than that in the internal reference electrode. However with an internal reference electrode in accordance with the present invention, the exhausted metallic component of an internal reference electrode can be recovered. Hence, Ni particles in the IRE will eventually be oxidized in the long run when the sample pO₂ is higher than the equilibrium pO₂ of Ni/NiO. This will cause the cell voltage to approach zero. Two IROSes with different initial IRE reduction degree were compared over time as shown in the graph below, FIG. 5. Both cells had the structure of (Au)IRE/8YSZ/Pt and were reduced at 1.1 V.

The ‘(Au)’ left to the ‘IRE’ in the cell structure notation means that the IRE has an Au coating. One IRE (filled squares) had 67% of NiO reduced while the other (filled circle) had 11% of NiO reduced. The voltage of the former cell did not show any voltage decrease after 90 hours of test, whereas the voltage of the latter cell started to decrease after 15 hours. With a recovery (“recharge”) at 1.1 V for 3 hours the voltage of the latter cell was restored. This means that the cell voltage decrease due to Ni depletion is recoverable.

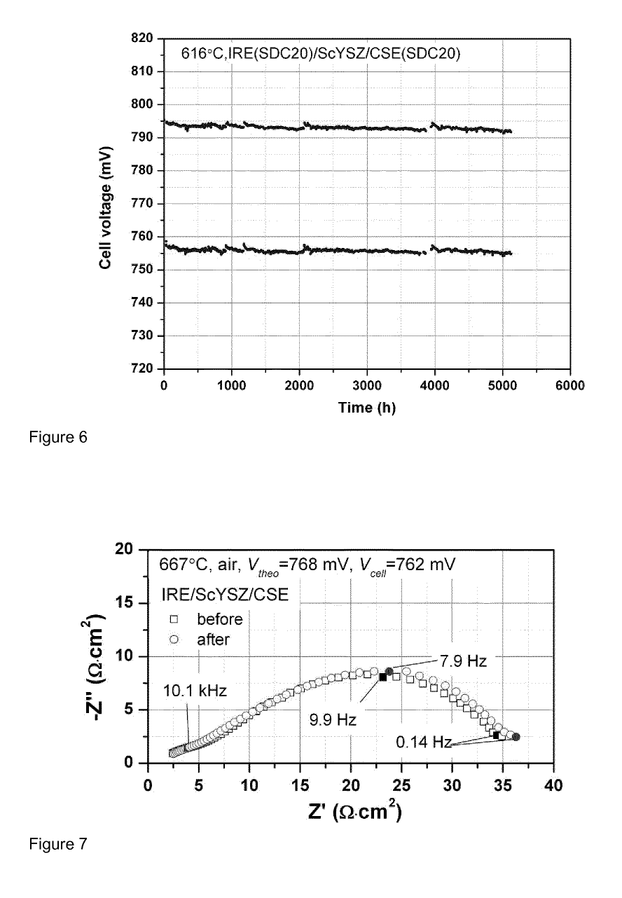

The graph below, FIG. 6, shows a stability test of a cell with structure IRE(SDC20)/ScYSZ/CSE(SDC20). The test included oxygen partial pressure cycling between 0.025 and 0.2 atm every 12 hours, giving cell voltages at two levels. The cell, having 43% NiO reduced in the IRE, had no any recovery operation during the test. As seen from the Figure, the cell voltage was still stable after 5100 hours. Due to disturbances from impedance spectroscopy and slight operation condition variations, such as humidity and temperature fluctuations, minor fluctuations of few mV in the cell voltage were seen.

The tolerance of the cell towards thermal cycling was examined by thermal cycling between 667° C. and 29° C. as shown below by FIG. 7. The cell voltages kept same after the thermal cycling, 762 mV at 667° C. with air at SE. The impedance spectra were also well maintained, indicating the cell electrochemical properties were not significantly affected by the thermal cycling. The test verified that the thermal expansion match among cell components has been realized to a large extent.

These examples accordingly demonstrate the surprising advantages associated with the aspects of the present invention, i.e. the novel IRE, the novel SE as well as the novel IROS provided by the present invention.

1. An Internal Reference Oxygen Sensor (IROS) comprising a composite internal reference electrode, a sensing electrode and a solid electrolyte, wherein the composite internal reference electrode comprises a binary mixture metal/metal oxide and a further material or material mixture providing ion conductivity and electron conductivity as electrode material, and where the structure of the composite internal reference electrode material is a three dimensional network structure, where particles of the binary metal/metal oxide and particles of the further material or material mixture providing ion conductivity and electron conductivity as electrode material are finely dispersed within the entire electrode.

2. The IROS according to claim 1, wherein the size of the particles of the binary mixture metal/metal oxide and/or the particles of the further material or material mixture providing ion conductivity and electron conductivity lies in the range of less than 200 μm.

3. The IROS according claim 2, wherein the size of the particles of the binary mixture metal/metal oxide and/or the particles of the further material or material mixture providing ion conductivity and electron conductivity lies in the range of less than 100 nm.

4. The IROS according to claim 1, wherein the further material or material mixture providing ion and electron conductivity is selected among ceramic materials, and refractory oxides.

5. The IROS according to claim 1, wherein the further material or material mixture providing ion and electron conductivity is selected among
a) undoped perovskites with general formula:
PMO₃ where P═La, Sr, and M=Sc, Ti, V, Cr, Mn, Fe, Co, Ni, Cu, Zn, Ga, Ge, or Al;
b) layered oxides with undoped perovskite-like structures with general formula:
P₂MO₄ where P═La, Sr and M=Sc, Ti, V, Cr, Mn, Fe, Co, Ni, Cu, Zn, Ga, Ge, or Al;
c) A-site doped perovskites with general formula:
(P₁₋ₓQₓ)_{y}MO₃ where P═La, Y, Pr, Tb, Q=Ca, Sr, Ba, and M=Sc, Ti, V, Cr, Mn, Fe, Co, Ni, Cu, Zn, Ga, Ge, or Al (with 0≦x≦1 and 0 y≦1, preferably 0.25≦x≦0.55 and 0.95≦y≦1);
d) A- and B-site doped perovskites with general formula:
(P₁₋ₓQₓ)M_{1-y}N_{y}O₃ where P═Y, Ca, Sr, Ba, Ce, Pr, Nd, Sm, Eu, Gd, Tb, Dy, Ho, Er, Tm, Yb, or Lu, Q=Y, Ca, Sr, Ba, Pr, Nd, Sm, Eu, Gd, Tb, Dy, Ho, Er, Tm, Yb, or Lu such that the elements chosen for P and Q are different from each other; M=Sc, Ti, V, Cr, Mn, Fe, Co, Ni, Cu, Zn, Ga, Ge, Al and N═Sc, Ti, V, Cr, Mn, Fe, Co, Ni, Cu, Zn, Ga, Ge, or Al such that the elements chosen for M and N are different from each other, with 0≦x≦1 and 0≦y≦1, preferably 0.25≦x≦0.55 and 0.25≦y≦0.55;
e) zirconia based solid solutions:
ZrO₂-MO where M=Mg or Ca;
ZrO₂-M₂O₃ where M=Sc, Y, La, Pr, Nd, Sm, Eu, Gd, Tb, Dy, Ho, Er, Tm, Yb, or Lu;
ZrO₂—Bi₂O₃-M₂O₃ where M=Sc, Y, La, Pr, Nd, Sm, Eu, Gd, Tb, Dy, Ho, Er, Tm, Yb, or Lu;
f) hafnia based solid solutions:
HfO₂-MO where M=Mg or Ca; or
HfO₂-M₂O₃ where M=Sc, Y, La, Pr, Nd, Sm, Eu, Gd, Tb, Dy, Ho, Er, Tm, Yb, or Lu;
g) ceria based solid solutions:
CeO₂-MO where M=Mg, Ca, or Sr; or
CeO₂-M₂O₃ where M=Sc, Y, La, Pr, Nd, Sm, Eu, Gd, Tb, Dy, Ho, Er, Tm, Yb, or Lu;
h) thoria based solid solutions:
ThO₂-MO where M=Mg, Ca, Sr, or Ba; or
ThO₂-M₂O₃ where M=Sc, Y, La, Pr, Nd, Sm, Eu, Gd, Tb, Dy, Ho, Er, Tm, Yb, or Lu;
i) urania based solid solutions:
UO₂-MO where M=Mg, Ca, Sr, or Bar; or
UO₂-M₂O₃ where M=Sc, Y, La, Pr, Nd, Sm, Eu, Gd, Tb, Dy, Ho, Er, Tm, Yb, or Lu;
j) bismuth oxide based solid solutions:
Bi₂O₃-MO where M=Mg, Ca, Sr, Ba, or Pb;
Bi₂O₃-M₂O₃ where M=Sc, Y, La, Pr, Nd, Sm, Eu, Gd, Tb, Dy, Ho, Er, Tm, or Yb;
Bi₂O₃—WO₃; or
Bi₂O₃.(PbO)₁₋ₓ.(CaO)ₓ, with 0≦x≦1, preferably 0.4≦x≦0.8; and
k) oxygen saturated fluorites:
CaF₂—CaO; or
BaF₂—BaO;
and any mixtures thereof.

6. The IROS according to claim 1, wherein the binary mixture metal/metal oxide is selected among nickel/nickel oxide, palladium/palladium oxide, iron/iron oxide, cobalt/cobalt oxide, copper/copper oxide, tungsten/tungsten oxide, titanium/titanium oxide, vanadium/vanadium oxide, chromium/chromium oxide, manganese/manganese oxide, zinc/zinc oxide, niobium/niobium oxide, molybdenum/molybdenum oxide, ruthenium/ruthenium oxide, rhodium/rhodium oxide, silver/silver oxide, cadmium/cadmium oxide, indium/indium oxide, tin/tin oxide, antimony/antimony oxide, tellurium/tellurium oxide, tantalum/tantalum oxide, rhenium/rhenium oxide, osmium/osmium oxide, iridium/iridium oxide, platinum/platinum oxide, thallium/thallium oxide, lead/lead oxide, preferably among nickel and nickel oxide, cobalt and cobalt oxide, iron and iron oxide as well as rhodium and rhodium oxide.

7. The IROS according to claim 1, wherein the composite internal reference electrode is obtained by mixing the further material or material mixture providing ion and electron conductivity with the metal oxide of the binary mixture metal/metal oxide, wherein the metal of the binary mixture metal/metal oxide is prepared after formation of the principle internal reference electrode structure by electrochemical reduction of the metal oxide.

8. The IROS according to claim 1, wherein the sensing electrode is a composite sensing electrode comprising a material or material mixture providing ion conductivity and electron conductivity.

9. The IROS according to claim 8, wherein the structure of the composite sensing electrode material is a three dimensional network structure, where particles of the material providing ion conductivity and particles of the material providing electron conductivity are finely dispersed within the entire electrode.

10. The IROS according to claim 9, wherein the size of the particles of the material providing ion conductivity and/or the particles of the material providing electron conductivity lies in the range of less than 200 μm.

11. The IROS according claim 10, wherein the size the particles of the material providing ion conductivity and/or the particles of the material providing electron conductivity lies in the range of less than 100 nm.

12. The IROS according to claim 8, wherein the material providing ion conductivity is selected among ceramic materials and refractory oxides.

13. The IROS according to claim 8, wherein the material providing ion conductivity is selected among
a) undoped perovskites with general formula:
PMO₃ where P═La, Sr, and M=Sc, Ti, V, Cr, Mn, Fe, Co, Ni, Cu, Zn, Ga, Ge, or Al;
b) layered oxides with undoped perovskite-like structures with general formula:
P₂MO₄ where P═La, Sr and M=Sc, Ti, V, Cr, Mn, Fe, Co, Ni, Cu, Zn, Ga, Ge, or Al;
c) A-site doped perovskites with general formula:
(P₁₋ₓQₓ)_{y}MO₃ where P═La, Y, Pr, Tb, Q=Ca, Sr, Ba, and M=Sc, Ti, V, Cr, Mn, Fe, Co, Ni, Cu, Zn, Ga, Ge, or Al (with 0≦x≦1 and 0 y≦1, preferably 0.25≦x≦0.55 and 0.95≦y≦1);
d) A- and B-site doped perovskites with general formula:
(P₁₋ₓQₓ)M_{1-y}N_{y}O₃ where P═Y, Ca, Sr, Ba, Ce, Pr, Nd, Sm, Eu, Gd, Tb, Dy, Ho, Er, Tm, Yb, Lu, Q=Y, Ca, Sr, Ba, Pr, Nd, Sm, Eu, Gd, Tb, Dy, Ho, Er, Tm, Yb, or Lu such that the elements chosen for P and Q are different from each other; M=Sc, Ti, V, Cr, Mn, Fe, Co, Ni, Cu, Zn, Ga, Ge, or Al and N═Sc, Ti, V, Cr, Mn, Fe, Co, Ni, Cu, Zn, Ga, Ge, or Al such that the elements chosen for M and N are different from each other, with 0≦x≦1 and 0≦y≦1, preferably 0.25≦x≦0.55 and 0.25≦y≦0.55;
e) zirconia based solid solutions:
ZrO₂-MO where M=Mg or Ca;
ZrO₂-M₂O₃ where M=Sc, Y, La, Pr, Nd, Sm, Eu, Gd, Tb, Dy, Ho, Er, Tm, Yb, or Lu; or
ZrO₂—Bi₂O₃-M₂O₃ where M=Sc, Y, La, Pr, Nd, Sm, Eu, Gd, Tb, Dy, Ho, Er, Tm, Yb, or Lu;
f) hafnia based solid solutions:
HfO₂-MO where M=Mg or Ca; or
HfO₂-M₂O₃ where M=Sc, Y, La, Pr, Nd, Sm, Eu, Gd, Tb, Dy, Ho, Er, Tm, Yb, or
g) ceria based solid solutions:
CeO₂-MO where M=Mg, Ca, or Sr; or
CeO₂-M₂O₃ where M=Sc, Y, La, Pr, Nd, Sm, Eu, Gd, Tb, Dy, Ho, Er, Tm, Yb, or Lu;
h) thoria based solid solutions:
ThO₂-MO where M=Mg, Ca, Sr, or Ba; or
ThO₂-M₂O₃ where M=Sc, Y, La, Pr, Nd, Sm, Eu, Gd, Tb, Dy, Ho, Er, Tm, Yb, or Lu;
urania based solid solutions:
UO₂-MO where M=Mg, Ca, Sr, or Bar; or
UO₂-M₂O₃ where M=Sc, Y, La, Pr, Nd, Sm, Eu, Gd, Tb, Dy, Ho, Er, Tm, Yb, or Lu;
j) bismuth oxide based solid solutions:
Bi₂O₃-MO where M=Mg, Ca, Sr, Ba, or Pb;
Bi₂O₃-M₂O₃ where M=Sc, Y, La, Pr, Nd, Sm, Eu, Gd, Tb, Dy, Ho, Er, Tm, or Yb;
Bi₂O₃—WO₃; or
Bi₂O₃.(PbO)₁₋ₓ.(CaO)ₓ, with 0≦x≦1, preferably 0.4≦x≦0.8; and
k) oxygen saturated fluorites:
CaF₂—CaO or
BaF₂—BaO,
and any mixtures thereof,
optionally wherein the material providing ion conductivity is selected among optionally doped LaMnO₃, LaCoO₃, (La, Sr)MnO₃, ZrO₂, and CeO₂ and yttria stabilized zirconia and lanthanides based oxides, wherein the lanthanides optionally are selected among Ce, Pr, Nd, Sm, Eu, Gd, Tb, Dy, Ho, Er, Tm, Yb, or Lu.

14. The IROS according to claim 8, wherein the material providing electron conductivity of the composite sensing electrode is selected among ceramic materials and refractory oxides.

15. The IROS according to claim 12, wherein the material providing electron conductivity of the composite sensing electrode is selected among
a) undoped perovskites with general formula:
PMO₃ where P═La, Sr, and M=Sc, Ti, V, Cr, Mn, Fe, Co, Ni, Cu, Zn, Ga, Ge, or Al;
b) layered oxides with undoped perovskite-like structures with general formula:
P₂MO₄ where P═La, Sr and M=Sc, Ti, V, Cr, Mn, Fe, Co, Ni, Cu, Zn, Ga, Ge, or Al;
c) A-site doped perovskites with general formula:
(P₁₋ₓ)_{y}MO₃ where P═La, Y, Pr, Tb, Q=Ca, Sr, Ba, and M=Sc, Ti, V, Cr, Mn, Fe, Co, Ni, Cu, Zn, Ga, Ge, or Al (with 0≦x≦1 and 0 y≦1, preferably 0.25≦x≦0.55 and 0.95≦y≦1);
d) A- and B-site doped perovskites with general formula:
(P₁₋ₓQₓ)M_{1-y}N_{y}O₃ where P═Y, Ca, Sr, Ba, Ce, Pr, Nd, Sm, Eu, Gd, Tb, Dy, Ho, Er, Tm, Yb, or Lu, Q=Y, Ca, Sr, Ba, Pr, Nd, Sm, Eu, Gd, Tb, Dy, Ho, Er, Tm, Yb, or Lu such that the elements chosen for P and Q are different from each other; M=Sc, Ti, V, Cr, Mn, Fe, Co, Ni, Cu, Zn, Ga, Ge, Al and N═Sc, Ti, V, Cr, Mn, Fe, Co, Ni, Cu, Zn, Ga, Ge, or Al such that the elements chosen for M and N are different from each other, with 0≦x≦1 and 0≦y≦1, preferably 0.25≦x≦0.55 and 0.25≦y≦0.55;
e) zirconia based solid solutions:
ZrO₂-MO where M=Mg or Ca;
ZrO₂-M₂O₃ where M=Sc, Y, La, Pr, Nd, Sm, Eu, Gd, Tb, Dy, Ho, Er, Tm, Yb, or Lu; or
ZrO₂—Bi₂O₃-M₂O₃ where M=Sc, Y, La, Pr, Nd, Sm, Eu, Gd, Tb, Dy, Ho, Er, Tm, Yb, or Lu;
f) hafnia based solid solutions:
HfO₂-MO where M=Mg or Ca; or
HfO₂-M₂O₃ where M=Sc, Y, La, Pr, Nd, Sm, Eu, Gd, Tb, Dy, Ho, Er, Tm, Yb, or Lu;
g) ceria based solid solutions:
CeO₂-MO where M=Mg, Ca, or Sr; or
CeO₂-M₂O₃ where M=Sc, Y, La, Pr, Nd, Sm, Eu, Gd, Tb, Dy, Ho, Er, Tm, Yb, or Lu;
h) thoria based solid solutions:
ThO₂-MO where M=Mg, Ca, Sr, or Ba; or
ThO₂-M₂O₃ where M=Sc, Y, La, Pr, Nd, Sm, Eu, Gd, Tb, Dy, Ho, Er, Tm, Yb, or Lu;
i) urania based solid solutions:
UO₂-MO where M=Mg, Ca, Sr, or Ba; or
UO₂-M₂O₃ where M=Sc, Y, La, Pr, Nd, Sm, Eu, Gd, Tb, Dy, Ho, Er, Tm, Yb, or Lu;
j) bismuth oxide based solid solutions:
Bi₂O₃-MO where M=Mg, Ca, Sr, Ba, or Pb;
Bi₂O₃-M₂O₃ where M=Sc, Y, La, Pr, Nd, Sm, Eu, Gd, Tb, Dy, Ho, Er, Tm, or Yb;
Bi₂O₃—WO₃; or
Bi₂O₃.(PbO)₁₋ₓ.(CaO)ₓ, with 0≦x≦1, preferably 0.4≦x≦0.8; and
k) oxygen saturated fluorites:
CaF₂—CaO or
BaF₂—BaO
and any mixtures thereof,
optionally wherein the material providing electron conductivity is selected among optionally doped LaMnO₃, LaCoO₃, (La, Sr)MnO₃, ZrO₂, and CeO₂ and yttria stabilized zirconia and lanthanides based oxides, wherein the lanthanides preferably are selected among Ce, Pr, Nd, Sm, Eu, Gd, Tb, Dy, Ho, Er, Tm, Yb, Lu.

16. The IROS according to claim 1to 15, wherein the electrolyte is selected among
a) zirconia based solid solutions:
ZrO₂-MO where M=Mg, Ca, or Ba;
ZrO₂-M₂O₃ where M=Sc, Y, La, Pr, Nd, Sm, Eu, Gd, Tb, Dy, Ho, Er, Tm, Yb, or Lu; or
ZrO₂—Bi₂O₃-M₂O₃ where M=Sc, Y, La, Pr, Nd, Sm, Eu, Gd, Tb, Dy, Ho, Er, Tm, Yb, Lu;
b) hafnia based solid solutions:
HfO₂-MO where M=Mg, Ca, Sr, or Ba; or
HfO₂-M₂O₃ where M=Sc, Y, La, Pr, Nd, Sm, Eu, Gd, Tb, Dy, Ho, Er, Tm, Yb, or Lu;
c) ceria based solid solutions:
CeO₂-MO where M=Mg, Ca, Sr, or Ba; or
CeO₂-M₂O₃ where M=Sc, Y, La, Pr, Nd, Sm, Eu, Gd, Tb, Dy, Ho, Er, Tm, Yb, or Lu;
d) thoria based solid solutions:
ThO₂-MO where M=Mg, Ca, Sr, or Ba; or
ThO₂-M₂O₃ where M=Sc, Y, La, Pr, Nd, Sm, Eu, Gd, Tb, Dy, Ho, Er, Tm, Yb, or Lu;
e) urania based solid solutions:
UO₂-MO where M=Mg, Ca, Sr, or Ba; or
UO₂-M₂O₃ where M=Sc, Y, La, Pr, Nd, Sm, Eu, Gd, Tb, Dy, Ho, Er, Tm, Yb, or Lu;
f) bismuth oxide based solid solutions:
Bi₂O₃-MO where M=Mg, Ca, Sr, Ba, or Pb;
Bi₂O₃-M₂O₃ where M=Sc, Y, La, Pr, Nd, Sm, Eu, Gd, Tb, Dy, Ho, Er, Tm, or Yb;
Bi₂O₃—WO₃; or
Bi₂O₃.(PbO)₁₋ₓ.(CaO)ₓ, with 0≦x≦1, preferably 0.4≦x≦0.8; and
g) oxygen saturated fluorites:
CaF₂—CaO or
BaF₂—BaO;
and any mixtures thereof.

17. A composite internal reference electrode as defined in claim 1.

18. A composite sensing electrode as defined in claim 9, further comprising a mixture of yttria stabilized zirconia with (La, Sr)MnO₃.
